(19) United States
(12) Patent Application Publication
(10) Pub. No.: US 2026/0252402 A1
(43) Pub. Date: Aug. 27, 2026

(54) Method of Automatically Evaluating a Proper Functioning of a Computing System Configured as a Centralized On-Board Computing System for a Vehicle

(71) Applicant: Volkswagen Aktiengesellschaft, Wolfsburg (DE)

(72) Inventor: Andreas Aal, Braunschweig (DE)

(73) Assignee: Volkswagen Aktiengesellschaft, Wolfsburg (DE)

(21) Appl. No.: 19/160,176

(22) PCT Filed: Jul. 28, 2023
(86) PCT No.: PCT/EP2023/070994

§ 371 Date: Aug. 27, 2025

(30) Foreign Application Priority Data
Mar. 1, 2023 (WO) PCT/EP2023/055182
Apr. 5, 2023 (WO) PCT/EP2023/059070

(51) Int. Cl. G06F 9/50; B60R 16/023; G06F 8/36; G06F 9/48; G06F 11/08; H04L 9/40; H04L 67/10

(52) U.S. Cl. CPC G06F 9/5044; B60R 16/023; G06F 8/36; G06F 9/485; G06F 9/505; G06F 11/08; H04L 63/0428; H04L 63/108; H04L 67/10

(57) ABSTRACT

Disclosed is a method of evaluating a proper functioning of a computing system configured as a centralized on-board computing system for a vehicle, the method comprising: assigning to or accessing for one or more hardware entities an associated set of one or more individual property attributes representing one or more technical properties of the respective hardware entity; assigning to or accessing for one or more computer programs for a subset comprising two or more of the computer programs an associated set of one or more requirement attributes representing one or more specific hardware demands that the computer program or subset, respectively, requires for its proper execution on the computing platform; and comparing the respective individual hardware demands to the technical properties of the computing system to determine an evaluation result indicating whether the respective hardware demand can be met by the computing system.

### CROSS-REFERENCE TO RELATED APPLICATIONS

This application claims priority to PCT Application No. PCT/EP2023/055182, filed on Mar. 1, 2023 and PCT Application No. PCT/EP2023/059070, filed on Apr. 5, 2023 with the European Patent Office as PCT Receiving Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to the field of vehicle electronics, such as but not limited to automotive electronics. Specifically, the disclosure relates to a method of automatically evaluating a proper functioning of a computing system configured as a centralized on-board computing system for a vehicle, such as an automobile, to centrally control different functionalities of the vehicle. The disclosure further relates to an evaluation system for evaluating a proper functioning of such a computing system, and to a computer program or computer program product, each for performing the method, and to a vehicle comprising such an evaluation system for evaluating such computing system.

Typically, a modern vehicle, such as an automobile, comprises a plurality of different electronic components, including in particular so-called Electronic Control Units (ECUs) which are interconnected using one or more communication links or whole networks, such as bus systems, e.g., of the well-known CAN or LIN type. Moreover, Ethernet-based networks are becoming more and more relevant in that context. It is noted that while generally, in the field of automotive technology, the acronym is also frequently used to refer specifically to an engine control unit, this acronym is used herein in a broader sense to refer to any electronic controller or control unit for a vehicle, wherein an engine control unit is just one possible example of such a control unit.

Many ECUs are, in fact, embedded systems comprising hardware, such as a processing platform, and related software running on the processing platform. Accordingly, such an ECU forms an embedded system and when multiple ECUs are interconnected via a communication network, such network can be designated as a distributed embedded system (network). While such an “embedded” set-up is particularly useful in terms of its capability to provide real-time processing and an optimal fit of the software of a given ECU to its respective processing platform, it is typically difficult to extend or scale such embedded systems or to add new functionality.

An alternative approach, as presented herein, is based on the idea that rather than or instead of using dedicated software running on dedicated hardware to provide a certain specific functionality, i.e., the functionality of a particular ECU, a central computing architecture is wherein used, the desired different functionalities are provided by multiple different computer programs, esp. applications, running on a same CCU, which is thus a shared computing resource.

Particularly, such a CCU-based approach allows for more flexibility than traditional decentralized approaches in terms of extending, scaling, or reducing functionalities of a vehicle, as described above. However, such an approach raises other challenges, such as the need to intelligently co-design and/or manage software and hardware resources in order to avoid or limit disadvantages, such as resource contention or poor performance.

### SUMMARY

A need exists to provide an improved approach for evaluating a CCU comprising a computing platform and multiple computer programs using the computing platform as a shared computing resource in order to evaluate a proper functioning of the CCU. The need is addressed by the subject matter of the independent claim(s).

Embodiments of the invention are described in the dependent claims, the following description, and the drawings. In some embodiments, an evaluation may comprise determining whether or to what extent an overall computing demand of the computer programs exceeds the capabilities of the computing platform.

### BRIEF DESCRIPTION OF THE DRAWINGS

FIG. 1 illustrates, according to embodiments of the present solution, a first block diagram illustrating functional building blocks of an exemplary CCU and a related high-level communication structure for communication within the CCU and with CCU-external nodes;

FIG. 2 illustrates in more detail some of the example functional building blocks of the CCU of FIG. 1;

FIG. 3 illustrates, according to embodiments of the present solution, a first view of a second block diagram showing more details of the functional building blocks of the CCU of FIG. 1, with a focus on the redundant set-up of power supply and power supply coordination, control coordination, and computing coordination within the CCU;

FIG. 4 illustrates a second view of the second block diagram of FIG. 3, however now with a focus on abnormality detection in the power supply domain;

FIG. 5 illustrates a redundancy concept with multiple instantiations per master CE and/or per associated switching fabric;

FIG. 6 illustrates a classical strictly hierarchical communication scheme from the prior art, according to the PCI Express communication technology;

FIG. 7 illustrates, according to embodiments of the present solution, an example adapted communication scheme using the PCI Express technology as a basis;

FIG. 8 illustrates, according to embodiments of the present solution, various example communication links being enabled by the adapted communication scheme of FIG. 7;

FIG. 9 illustrates, according to embodiments of the present solution, a third block diagram 500 showing more details of an example CCU, e.g., the CCU of FIG. 1, particularly of its communication switch;

FIG. 10 illustrates, according to embodiments of the present solution, an example housing concept of an exemplary CCU, e.g., the CCU of FIG. 1;

FIG. 11 schematically illustrates an example computing platform with a CCU of or for a vehicle;

FIG. 12 schematically illustrates a vehicle (specifically an automobile) comprising the computing platform of FIG. 1 and various different suitable locations for placing the CCU within the vehicle;

FIG. 13 schematically illustrates a simple example scenario where conflicting hardware demands of different computer programs might occur in a computing platform;

FIG. 14 schematically illustrates an example assignment of individual property attributes to hardware entities of a given computing system, and an assignment of requirement attributes to various computer programs of the computing system;

FIG. 15 schematically illustrates an example concept of an abstract hardware entity;

FIG. 16 shows a table defining various example individual property attributes, grouped in different property attribute categories;

FIG. 17 schematically illustrates a first embodiment of an example method; and

FIG. 18 schematically illustrates a second embodiment of the method.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

A first example aspect of the present solution is directed to a method of automatically evaluating a proper functioning of a computing system configured as a centralized on-board computing system for a vehicle to centrally control a variety of different functionalities of the vehicle.

The computing system comprises:
a computing platform having a plurality of hardware entities, and a plurality of different computer programs being configured for individual or concurrent execution on the computing platform to enable one or more of said functionalities of the vehicle.

The method comprises:
(i) assigning to or accessing for one or more of the hardware entities an associated set of one or more individual property attributes representing individually or jointly one or more technical properties of the respective hardware entity;
(ii) assigning to or accessing individually for one or more of the computer programs or jointly for a subset comprising two or more of the computer programs an associated set of one or more requirement attributes representing individually or jointly one or more specific hardware demands that the computer program or subset of computer programs, respectively, requires for its proper execution on the computing platform; and
(iii) comparing the respective individual hardware demands of one or more of the computer programs or a combined hardware demand of the subset of computer programs, respectively, to the technical properties of the computing platform as defined by the property attributes to determine an evaluation result indicating whether the respective hardware demand can be met by the computing system, or more specifically its computing platform.

Accordingly, the method of the first example aspect provides for an evaluation of the computing system based on a matching, i.e., comparison, of the specific hardware requirements the various computer programs place, individually or in combination, on the computing platform, and the technical properties of the hardware entities of the computing platform. If the matching results in a finding, that the technical properties of the hardware entities are sufficient to meet the hardware requirements, the evaluation result indicates this while otherwise it indicates a mismatch and/or a degree thereof. Accordingly, the evaluation determines whether the hardware requirements (i.e., the demand of the computer programs) meets or exceeds the capabilities of the computing system's hardware.

Specifically, the method does not only allow such an evaluation during runtime of the programs on the computing platform but may also or instead allow for a prior evaluation, particularly even a virtual evaluation, based on a mere virtual model once the hardware entities and their technical properties as well as the computer programs and their requirements on the hardware are known. Furthermore, potential mismatches can be detected even if at a given time during an execution of the one or more computer programs no issues are detected. This is because the issue might only occur when several computer programs were to run concurrently or if their start was non-synchronized.

The term “hardware entities” of the computing platform, as used herein, is an entity, such as a unit or module of the computing platform, which comprises hardware, such as active or passive electronic or optical devices, e.g., circuitry. For example, a hardware entity may comprise a hardware circuit comprising custom VLSI circuits or gate arrays, off-the-shelf semiconductors such as basic logic chips, transistors, or other discrete components. A hardware entity may also be implemented in programmable hardware means such as: programmable gate arrays, programmable array logic, programmable logic means or the like. A hardware entity may optionally also comprise software, such as firmware. Without limitation, processors, circuit boards (e.g., printed circuit boards, PCB), power supply modules, RF-circuits, communication interface devices, storage media, sensors, actuators, cameras, cables, cooling devices, and housings of the computing platform as a whole or parts thereof are each examples of hardware entities.

The term “accessing”, as used herein, may particularly refer to reading data stored in a memory or receiving data provided by a data stream provided by another entity, such as a computing platform-external entity, e.g., external computer.

The term “centrally control a variety of functionalities”, as used herein, refers to a controlling scheme, wherein a centralized non-embedded computing system is used to perform the controlling. The function of the centralized non-embedded computing system can be flexibly adapted during runtime by means of different computer programs that can be selectively executed individually or concurrently with one or more other computer programs on the computing system depending on one or more functionalities of the vehicle that the computing system is currently required to perform or control. Accordingly, such a computing system differs from a traditional distributed embedded system network in a vehicle, where the control functionality is predominantly split across a set of specialized electronic control units (ECU), each being an embedded system with a fixed, dedicated limited function within a larger mechanical or electronic subsystem (e.g., an infotainment or lighting system, or driver assistance system, etc.) of the vehicle.

The terms “first”, “second”, “third” and the like in the description and in the claims are used for distinguishing between similar elements and not necessarily for describing a sequential or chronological order. It is to be understood that the terms so used are interchangeable under appropriate circumstances, and that the embodiments described herein are capable of operation in other sequences than described or illustrated herein.

Unless the context requires otherwise, where the term “comprising” or “including” or a variation thereof, such as “comprises” or “comprise” or “include”, is used in the present description and claims, it does not exclude other elements or steps and are to be construed in an open, inclusive sense, that is, as “including but not limited to”.

Where an indefinite or definite article is used when referring to a singular noun, e.g., “a” or “an”, “the”, this includes a plural of that noun unless something else is specifically stated.

Appearances of the phrases “in some embodiments”, “in one embodiment” or “in an embodiment”, if any, in the description are not necessarily all referring to the same embodiment. Furthermore, the particular features, structures, or characteristics may be combined in any suitable manner in one or more embodiments.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Some embodiments of the method are described, which can be arbitrarily combined with each other or with other example aspects of the present teachings, unless such combination is explicitly excluded or technically impossible.

According to some embodiments, the computing system comprises a central computing unit, CCU, configured as a centralized on-board computing system for the vehicle to centrally control a variety of different functionalities of the vehicle, and the method is applied to automatically evaluate a proper functioning of the CCU. The CCU comprises:
(i) a distributed computing system, DCS, comprising a plurality of co-located (e.g., in a same housing, such as a closed housing or an open housing, e.g., a rack), autonomous computational entities, CEs, each of which has its own individual memory, wherein the CEs are configured to communicate among each other by message passing via one or more communication networks to coordinate among them an assignment of computing tasks to be performed by the DCS as a whole;
(ii) a communication switch comprising a plurality of mutually independent (i.e., at least functionally independent) switching fabrics, each configured to variably connect a subset or each of the CEs of the DCS to one or more of a plurality of interfaces for exchanging thereover information with computing system-external communication nodes of the vehicle. Such nodes may particularly be or comprise network endpoints, e.g., actuators or sensors, or intermediate network nodes, e.g., hubs, for connecting multiple other network A communication switch may particularly include, without limitation, one or more PCI Express (PCIe) switches and/or Compute Express Links (CXL) as switching fabrics; and
(iii) a power supply system comprising a plurality of power supply sub-systems for simultaneous operation, each of which is individually and independently of each other capable of powering the DCS and at least two, particularly all, of the switching fabrics.

The term “switching fabric”, as used herein, refers particularly to hardware for variably connecting multiple different nodes of a network, such as nodes of a computer network, to exchange data therebetween.

The terms “switching” or “switch”, as used herein (e.g., in the terms “switching fabric” and “communication switch”), refers generally to variably connecting different nodes of a network to exchange data therebetween, and unless explicitly specified otherwise herein in a given context, is not limited to any specific connection technology such as circuit switching or packet switching or any specific communication technology or protocol, such as Ethernet, PCIe, and the like.

The term “powering”, as used herein” means particularly delivering power to the entity to be powered and may optionally further comprise generating the power in the first place and/or converting it to a suitable power kind or level, e.g., by DC/DC, AC/DC, or DC/AC conversion, or a conversion of a time-dependency of a power signal (signal shaping).

The term “computational entity” or its abbreviation “CE”, as used herein, refers to an autonomous computing unit which is capable of performing computing tasks on its own and which comprises for doing so at least one own processor and at least one own associated memory. Particularly, each CE may be embodied separately from all other CEs. For example, it may be embodied in one or more circuits, such as in an integrated circuit (e.g., as a system-on-chip (SOC), a system-in-package (SIP), multi-chip module (MCM), or chiplet) or in a chipset.

Specifically, said communication network for communication among the CEs may be a high-speed communication network, e.g., of the on PCI Express or Ethernet type, to coordinate among them an assignment of computing tasks to be performed by the DCS as a whole. Particularly, in the case of multiple communication networks, these networks may be coupled in such a way as to enable the passing of a message between a sending CE and a receiving CE over a communication link that involves two or more of the multiple networks. For example, a given message may be sent from a sending CE in a PCI Express-format over one or more first communication paths in a PCI Express network to a gateway that then converts the message into an Ethernet-format and forwards the converted message over one or more second communication paths in an Ethernet-network to the receiving CE. The set of individual CEs of the DCS may particularly be configured to perform parallel task processing such that the CEs of the set simultaneously perform a set of similar or different computing tasks, e.g., such that each CE individually performs a true subset of the set of computing tasks to be performed by the DCS as a whole, wherein the computing tasks performed by different CEs may be different.

Particularly, each of said CEs, communication switch, switching fabric, and power supply system may be considered a “hardware entity”, as defined further above.

A CCU according to the present solution can provide several benefits, including one or more of the following:
(i) Easy scalability of the computing power (further CEs may be added or CEs may be removed, and computing tasks can be optimally distributed among the available CEs).
(ii) High degree of efficiency to perform many different kinds of computing tasks. For example, one or more CEs may specially adapt to perform certain specific tasks, such as machine learning, image rendering, real-time processing, general-purpose computing etc. all with the option for sequential as well as parallel processing so that computing tasks can be selectively performed by one or more suitably adapted specialized CEs within the DCS. Furthermore, the total amount of computing power being allocated by the DCS to a particular computing task may be variably adapted “on the fly”;
(iii) High degree of flexibility to perform many different and even varying kinds of computing tasks. In the conventional “world” of automotive ECUs, each ECUs is typically designed to meet a small and limited number of specified fixed and dedicated concrete functions being realized by the underlying ECU hardware and generally proprietary software especially composed for that hardware. Both hardware and software are intended to be almost unchanged until the vehicle reaches its end-of-life status-potentially except for some minor software-updates related to bug-fixes or small functional extensions. The present solution overcomes these limitations and enables not only a flexible allocation of computing tasks among the set of CEs, but also an extension or alteration of the computing tasks and hence functionalities the CCU can support. Particularly, software defining such functionalities may be easily updated or upgraded (e.g., “over the air”, OTA) to enable such extension or alteration and even new software may be easily added. Such changes on the software-level may even be performed very frequently, whenever needed. Furthermore, by adding, replacing, or removing individual CES or groups of CEs, even the underlying computing hardware may be easily adjusted to a changed or new set of functionalities to be supported.
(iv) High performance and power efficiency: due to the co-location, the communication links between the CEs can be kept short, thus enabling high-speed communication among them with little power loss and high signal quality. Accordingly, a high degree of performance, power efficiency and reliability of the DCS as a whole can be achieved.
(v) High reliability, due to a high degree of flexible redundancy both in regard to a flexible allocation of computing tasks to selected CEs and a redundant power supply.

In some embodiments, at least one of the computer programs, such as an application-level computer program, comprises two or more program modules designed for reuse by multiple ones of the computer programs. Each program module has or is assigned one or more individual module-level requirement attributes representing individually or jointly one or more specific hardware demands that the respective program module requires for its proper execution on the computing platform. Assigning the related set of one or more individual requirement attributes to each of these computer programs comprises deriving their respective set of individual requirement attributes, at least in parts, by combining, such as cumulating, the respective individual module-level requirement attributes being assigned to their respective program modules. Accordingly, the requirement attribute of one or more of the computer programs can be derived, at least in parts, automatically “bottom-up” based on those of the modules being incorporated in the computer program(s). This modular approach enables a highly efficient and flexible determination of requirement attributes of computer programs comprising such reusable program modules.

In some embodiments, the computing system comprises two or more of said computer programs and at least a subset of the reusable program modules are included as elements in an inventoried software module library in such a way that they can be individually integrated or accessed by different ones of the computer programs via the inventory, so that evaluating the proper functioning of the computing system comprises performing the evaluation based on said two or more computer programs including said subset of reusable program modules being integrated in or accessed by one or more of the computer programs, respectively. This library approach may particularly be used on a compiler level and/or linker level, i.e., the relevant software modules are taken from the library in object code and introduced, such as by linking, into the executable version of the considered computer program during its compilation. It may, however, be used instead on an interpreter level, i.e., if the computer program is available in some sort of source code and only gets interpreted, i.e., transformed into executable code, during runtime. In the latter case, the software modules may particularly be available in source code as well, so as to be interpreted along with the remainder of the computer program in question. In principle, even a combination of both options (compiler/linker and interpreter) are possible. Accordingly, the efficiency of the software programs in terms of one or more of reusability, code size, and reliability can be improved.

In some embodiments, defining the technical properties of the computing system through the set of the property attributes of the one or more hardware entities comprises defining one or more abstract hardware entities each of which virtually represents by means of a set of respective individual property attributes per each abstract hardware entity a group of different possible real instantiations of such a hardware entity. Accordingly, the abstract hardware entities can be considered as a sort of abstraction “layer” for of hiding the working details of a subsystem, i.e., differences between the different individual instantiations of a hardware entity, e.g., those of different suppliers, from other hardware or software entities of the computing system. This concept may be particularly useful for enabling or supporting a multi-sourcing scenario (e.g., a second-source scenario), where a system integrator has different suppliers for the hardware entities, all of which suppliers then need to meet a same or at least substantially similar specification for an abstract hardware entity in order to enable the multi-sourcing scenario at minimal additional burden to the system integrator.

In some embodiments, at least one of the property attributes is individually encoded by a respective unique and computer-readable property identifier. When comparing the individual hardware demands of the one or more computer programs or the combined, e.g., cumulated, hardware demand of the subset of computer programs (particularly for their concurrent execution), respectively, to the technical properties of the computing system, at least one of the property identifiers is decoded to determine the property attribute encoded by said property identifier as a basis for the comparison. Accordingly, a coding with identifiers is used to represent the property attributes within the computing system. Such a coding can enable a highly efficient representation of the property attributes that requires minimal storage space for storing same and/or minimal bandwidth for communicating same, e.g., within the computing system, and only relatively low processing efforts.

In some embodiments, at least one of the requirement attributes is individually encoded by a respective unique and computer-readable requirement identifier. When comparing the individual hardware demands of the one or more computer programs or the combined, e.g., cumulated, hardware demand of the subset of computer programs, respectively, to the technical properties of the computing system, at least one of the requirement identifiers is decoded to determine the requirement attribute encoded by said requirement identifier as a basis for the comparison. Accordingly, a coding with requirement identifiers is used to represent hardware demands within the computing system. Such a coding can enable a highly efficient representation of the hardware demands that requires minimal storage space for storing same and/or minimal bandwidth for communicating same, e.g., within the computing system, and only relatively low processing efforts. Furthermore, if both the property attributes and the hardware demands are each represented by respective identifiers, the comparison may even be performed on the code-level, in whole or in part, which can further enhance efficiency, because only the identifiers need then to be processed rather than more complicated descriptions or parameters of the relevant hardware and software components of the computing system.

In some embodiments, a string representation comprising two or more concatenated identifiers is used to represent a particular combination of selected identifiers as a basis for the comparison. Such a string representation. For example, the various included concatenated identifiers may be separated within the string by some separation symbol, such as a point, comma, or semicolon. The concatenated identifiers may either be property identifiers or requirement identifiers, or there might even be a mix of both. The same applies to the following embodiments when the term “identifier(s)” is used without indicating explicitly which type of identifier it is. Thus, using the string representation, a single string, that is a mere typically one-dimensional data structure, can be used to represent combinations of identifiers in a highly efficient manner.

In some embodiments, encryption technology is used to protect at least a subset of the one or more identifiers against unauthorized access. Particularly, such protection may be applied to a string representing a combination of multiple identifiers by means of concatenation, as discussed above. Protecting identifiers according to these embodiments helps to directly improve the integrity and security of the computing system and its operation as such, and indirectly also that of the operation of the vehicle's related functions. For example, if the computing system is configured to control a safety-relevant functionality of the vehicle, such as steering, braking, front or backlights, critical sensors etc., protecting the identifiers can help to prevent unauthorized interference with the evaluation process and thus may increase safety of the vehicle.

In some embodiments, obfuscation technology is used to protect at least a subset of the one or more identifiers against unauthorized access by applying time-variant associations between at least one particular identifier on and the respective information being temporarily encoded therewith on the other hand. Accordingly, rather than using (only) fixed, i.e., time-constant, associations, associations varying over time are introduced to further improve the achievable security level of the evaluation method and consequently even of the evaluated computing system itself. Obfuscation may particularly be combined with the aforementioned encryption technology to achieve an even higher combined security level.

In some embodiments, at least a subset of the attributes, i.e., property attributes and/or requirement attributes, is organized in a hierarchical order that is reflected in corresponding hierarchical codes used to encode the related set of identifiers. For example, the hierarchical code for a particular hardware demand for processing power might be defined by a code reflecting on a higher level of the hierarchy (e.g., a “category” level) a kind of processor needed (such as general CPU, graphic processor, encryption engine, or neural engine), and on a lower level (e.g., a “class” level) a minimum processing power to be provided by such processor. Using such a hierarchical approach can provide a very fast searching and access to critical information stored by means of such hierarchical codes and can thus help to enhance a performance level of the evaluation method. Particularly, this can support the purpose of selecting relevant attributes more efficiently by first picking only relevant categories and then considering only classes of relevant categories, while ignoring attributes in other categories.

In some embodiments, the method further comprises: preselecting, based on the set of the requirement attributes, a relevant subset of the property attributes of the processing platform, and performing the comparison, in terms of the property attributes being considered, strictly on the basis of the preselected property attributes. These embodiments as well can help to increase efficiency of the method, because the amount of property attributes which need to be considered during the evaluation process can be reduced. Specifically, for a given set of hardware capabilities of the computing system, e.g., of its processing platform, a selection of such computer programs the hardware demands of which can be met by the computing system, can be made based on said subset of the property attributes of the processing platform. This may particularly be used, in scenarios, where for a given functionality multiple computer programs or program modules are available to provide such functionality but which differ in their hardware requirements, e.g., because of different performance characteristics.

In some embodiments, the set of one or more computer programs (as a whole) or at least one of the computer programs therein is reconfigurable by adding, removing, enabling, or disabling or modifying one or more computer programs or computer program modules, respectively. The method then further comprises: (i) determining an actual or planned reconfiguration of the set of one or more computer programs or of at least one of the computer programs itself, and (ii) performing, particularly repeating, the method t determine, particularly also output, information indicating whether or not, according to the result of the related comparison, the respective individual or combined hardware demands of the set of one or more computer programs or the at least one computer program itself, when or if reconfigured accordingly including a respective updating of the related one or more requirement attributes, can be met by the technical properties of the computing system. Accordingly, the set of computer programs needs not be time-invariant but may instead evolve over time by reconfiguration. The method may therefore be adaptable according to these embodiments to reflect such reconfiguration and provide a related updated evaluation result taking the reconfiguration into account. Thus, the overall flexibility of the computer system and particularly the present method of evaluating it may be increased.

In some embodiments, the computing system is reconfigurable by adding, removing, enabling, or disabling or modifying, respectively, one or more of its hardware entities, e.g., in a plug-and-play manner. The method further comprises: (i) determining an actual or planned reconfiguration of the computing system; and (ii) performing, particularly repeating, the method to determine, particularly also output, information indicating whether or not, according to the result of the related comparison, the respective individual or combined hardware demands of the one or more computer programs can be met by the technical properties of the computing system, when or if reconfigured accordingly including a respective updating of the related one or more property attributes. Accordingly, the set of hardware entities, e.g., hardware modules, needs not be time-invariant but may instead evolve over time by reconfiguration. The method may therefore be adaptable according to these embodiments to reflect such reconfiguration and provide a related updated evaluation result taking the reconfiguration into account. Thus, the overall flexibility of the computer system and particularly the present method of evaluating it may be increased. Specifically, the re-configurability in terms of the hardware entities side may be complemented by the re-configurability in terms of computer programs discussed above to achieve a maximum flexibility allover of both the computing system and its evaluation by the present method.

In some embodiments, the method further comprises one or more of the following actions in response to determining that according to the result of the related comparing, the respective individual or combined hardware demands of the one or more computer programs cannot be met by the technical properties of the computing system:
Initiating a warning signal;
Disabling one or more functionalities of the computing system or its operation as a whole;
Interrupting or otherwise disabling execution of at least one of the computer programs on the computing system;
Outputting further information indicating a property attribute or other related hardware requirement that according to the result of the related comparison cannot be met;
Outputting further information indicating a degree to which a property attribute or other related hardware requirement cannot be met according to the result of the related comparison;
Preventing an updating of one or more of the computer programs or of one or more computer program modules incorporated therein;
Communicating a result of the comparing to a remotely accessible computing environment or data storage;
Requesting or proposing an exchange of one or more hardware entities of the computing system or an addition of one or more other or further hardware entities to the computing system, such as to enable the computing system to meet said respective individual or combined hardware demand;
Estimating, for a defined time interval, a probability that an exchange or addition of one or more hardware entities of the computing system becomes necessary with the time interval in order to meet expected individual or combined hardware demands based on a trend analysis of previously occurring computer program updating and/or upgrading cycles.

In this way, a negative outcome of the evaluation (i.e., a result indicating insufficiency of the technical properties of the computing system) may be used to trigger, esp. automatically, any one or more of the above warning signals or other countermeasures.

In some embodiments, comparing comprises taking into account a predefined headroom requirement for the computing system as a further hardware demand for determining whether the respective hardware demand of a computer program or the combined hardware demand of two or more of the computer programs, respectively, can be met by the technical properties of the computing system. Accordingly, the evaluation method is “sharpened” in that a negative evaluation result may in some instances even be determined, when in fact all hardware demands except the headroom requirement(s) can be met. This ensures, that a positive evaluation result is only achieved when there is enough headroom as well. The headroom requirement may, however, also be defined so that a maximum headroom is defined (e.g., in addition to a minimum headroom). Accordingly, the evaluation can take into account both a need for a reserve in view of potential future software reconfiguration, e.g., changes such as extensions or modifications on the computer program side, and a need to keep headroom low enough to avoid unnecessary over-dimensioning or over-allocation of resources on the hardware side.

In some embodiments, the method is performed using at least one of the following: (i) an operating system (i.e., an OS software, such as LINUX) running on the computing system itself; (ii) a processing apparatus or environment other than the computing system of the computing system. For example, such other processing apparatus or environment may be a specific computer, such as a particular server in a backend or a processing platform, local or distributed, e.g., in a cloud computing environment, that is only temporarily assigned to perform the method or parts thereof. This allows for a high degree of flexibility without burdening the computer system itself with the performing of the method. In the first case (i), however, a benefit is a high degree of self-reliance of the computer-system.

In some embodiments, at least one computer program being involved in the comparing of the respective individual hardware demands of one or more of the computer programs or a combined hardware demand of the subset of computer programs, respectively, to the technical properties of the computing unit is a respective updated or upgraded version of a computer program a prior version of which already belongs to the computing system, in addition to or instead of the prior version. Accordingly, such a change on the computer program level of the computing system can be evaluated prior to operating the updated or upgraded version(s), and even before installing them. This approach may provide a number of benefits. Particularly, it can allow, e.g., a sales team, to define optimized commercial bundles of program updates associated with hardware upgrades based on a real metric (provided by the evaluation) based on both hardware and software-related aspects of the computing system. For example, this may serve as a basis for properly partitioning a customer function bundle to create offers and define computing systems and based with predictable and/or calculable costs related to software updates/upgrades that require hardware upgrades/changes to meet their related hardware demands. Specifically, a partitioning of customer function portfolios per vehicle segment (e.g., based on a public vehicle segmentation, such as ACRISS (Association of Car Rental Industry Systems Standards), that by the European Commission (defined in REGULATION (EEC) No 4064/89), or that of the German Kraftfahrtbundesamt (KBA)), or on a proprietary, e.g., manufacturer-specific, vehicle segmentation) may thus be performed. Accordingly, optima esp. in terms of costs or optimal combinations of supported functions at a given cost point may thus be easily defined based on the evaluation alone, i.e., without a need to build prototypes or even real computing systems before. Further benefits may include: allowing, e.g., an application software development team, to re-assess and/or change the software side of the computing system while maintaining or reaching a matching with the available hardware side of it; allowing, e.g., a system architect, to design scalable hardware based on an actual software based scale metric; enabling automatic blockades of software updates to prevent functional deviations, e.g., from a specification of the computing system or even the vehicle; allowing an assessment of a fit of the software side to the hardware side of the computing system even in the absence of one or both of them, particularly because the generated identifiers discussed above can be used separately thereof.

In some embodiments, when the evaluation result indicates that the individual hardware demand of the updated or upgraded version or a combined hardware demand of the subset of computer programs including the updated or upgraded version, respectively, cannot be met by the computing system, one or more operational parameters of the updated or upgraded version are modified such as to reduce its hardware demand, and the evaluation is repeated based on such reduced hardware demand. Accordingly, the method then takes the evaluation result into account to proactively modify the said one or more operational parameters such as to stepwise approach or even immediately achieve a match between the hardware side and the software side of the updated/upgraded computing system. The repeated evaluation may particularly serve to verify that the match has eventually been reached, if so. Furthermore, said adaption is particularly directed to operational parameters of the updated or upgraded version of the software (computer program(s)). That is, the matching is achieved by optimizing a configuration of the updated or upgraded version rather than by simply blocking such an update or upgrade. This provides the opportunity to (even automatically) achieve a match even in (at least selected) situations when the updated or upgraded version may not be suitable in all possible configurations thereof.

In some embodiments, said functionalities of the vehicle comprise one or more of the following, at least in parts: engine control, entertainment and/or infotainment, lighting, locking, air conditioning, braking, driver assistance, navigation, (esp. highly) automated or autonomous driving, vehicle internal or external communication, configuration of the vehicle's interior. The evaluation is performed to evaluate a proper functioning of the computing system in relation to its capability to properly perform at least one or a combination of two or more of said functionalities. Accordingly, the set of functionalities may span a rather wide range of different functionalities of the vehicle, all supported by the same computing system.

In some embodiments, the method further comprises an initialization process comprising one or more of:
automatically detecting one or more of the hardware entities and determining or receiving for each of these hardware entities its respective associated set of one or more individual property attributes;
receiving information specifying one or more of the hardware entities and determining or receiving for each of these hardware entities its respective associated set of one or more individual property attributes;
automatically detecting one or more of the computer programs and determining or receiving for each of these computer programs individually or for a set comprising two or more of these computer programs an associated set of one or more requirement attributes representing individually or jointly one or more specific hardware demands that this computer program or set of computer programs, respectively, requires for its proper execution on the computing platform;
receiving information specifying one or more of the computer programs and determining or receiving for each of these computer programs individually or for a set comprising two or more of these computer programs an associated set of one or more requirement attributes representing individually or jointly one or more specific hardware demands that this computer program or set of computer programs, respectively, requires for its proper execution on the computing platform.

Thus, the method may be extended to include the initialization process to provide information that can then be used in the subsequent actual evaluation process. Particularly, such an extension of the method may help to achieve an even higher degree of automatization of the overall evaluation of the computing system, in that the provision of the information that serves as an input to the evaluation is made available automatically, at least in part, without a need for human interaction. This may particularly allow for a higher performance all over, even up to real-time performance.

A second example aspect of the present solution is directed to an evaluation system for evaluating a proper functioning of a computing system being configured as an on-board computing system for a vehicle to centrally control different functionalities of the vehicle and comprising a computing platform having a plurality of hardware entities, and a plurality of different computer programs being configured for individual or concurrent execution on the computing platform. The evaluation system comprises a data processing apparatus comprising a processor configured to perform the method of any one of the preceding claims to evaluate a proper functioning of the computing system.

A third example aspect of the present solution is directed to a computing system configured as a centralized on-board computing system for a vehicle, such as an automobile, to centrally control different functionalities of the vehicle, wherein the computing system comprises the evaluation system of the second example aspect for evaluating a proper functioning of the computing system itself.

In some embodiments of the computing system, it comprises a central computing unit, CCU, configured as an on-board computing unit for the centrally vehicle to control different functionalities of the vehicle. The CCU comprises:
(i) a distributed computing system, DCS, comprising a plurality of co-located, autonomous computational entities, CEs, each of which has its own individual memory, wherein the CEs are configured to communicate among each other by message passing via one or more communication networks to coordinate among them an assignment of computing tasks to be performed by the DCS as a whole;
(ii) a communication switch comprising a plurality of mutually independent switching fabrics, each configured to variably connect a subset or each of the CEs of the DCS to one or more of a plurality of interfaces for exchanging thereover information with computing system-external communication nodes of the vehicle; and (iii) a power supply system comprising a plurality of power supply which is sub-systems for simultaneous operation, each of individually and independently of each other capable of powering the DCS and at least two of the switching fabrics.

Specifically, the CCU may comprise the evaluation system of the second example aspect for evaluating a proper functioning of the computing system, particularly of the CCU, itself.

A fourth example aspect of the present solution is directed to a vehicle comprising a computing system of the third example aspect as a centralized on-board computing system.

A fifth example aspect of the present solution is directed to a computer program or a non-transitory computer-readable storage medium, in each case comprising instructions which when executed on a computer or a multi-computer platform cause the computer or multi-computer platform, respectively, to perform the method of the first example aspect.

The computer program or non-transitory computer-readable storage medium, respectively, may be implemented in the form of a data carrier on which one or more programs for performing the method are stored. For example, such data carrier may comprise a hard drive or a semiconductor storage device, such as a flash memory module or embedded flash memory of a microcontroller and/or microprocessor. In another implementation, the computer program is provided as a file on a data processing unit, e.g., on a server, and can be downloaded via a data connection, e.g., the Internet or a dedicated data connection, such as a proprietary or local area network.

The evaluation system of the second example aspect may accordingly have a program memory in which the computer program is stored. Alternatively, the evaluation system may also be set up to access a computer program available externally, for example on one or more servers or other data processing units, via a communication link, in particular to exchange with it data being used in the course of the execution of the computer program or representing outputs of the computer program.

All explanations given with regard to the method of the first example aspect are fully applicable to each of the further example aspects of the present teachings as well.

Reference will now be made to the drawings in which the various elements of embodiments will be given numerical designations and in which further embodiments will be discussed.

In the FIGS., in many instances, identical reference signs are used for the same or mutually corresponding elements of the computing platform described herein. For the sake of clarity, the following detailed description is structured into sections introduced in each case by a heading. These headings are, however, not to be understood as limiting the content of the respective section corresponding to a heading or of any FIGS. described therein.

### Central Computing Unit, CCU

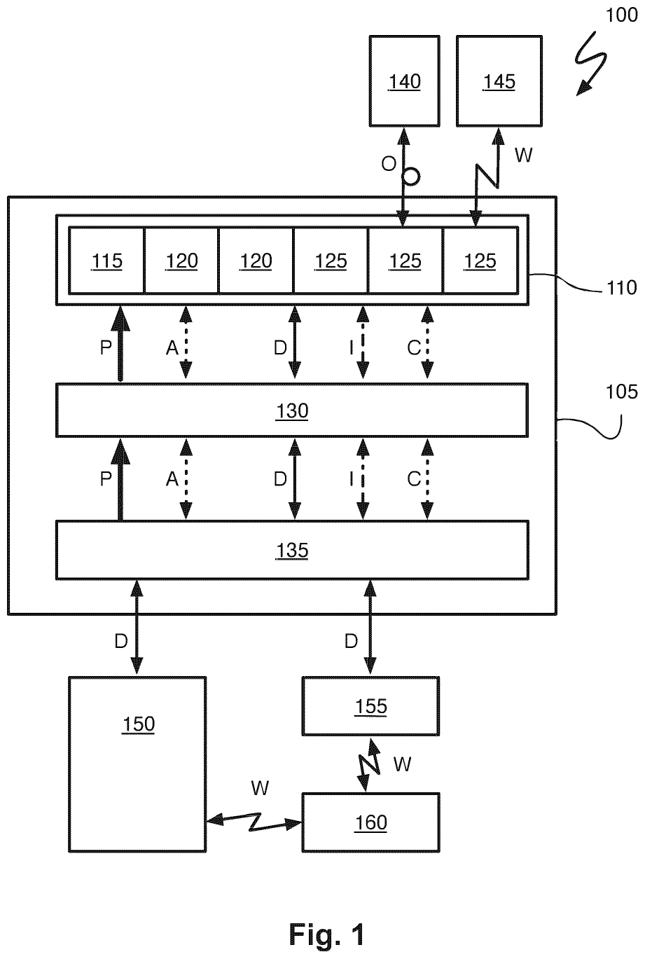

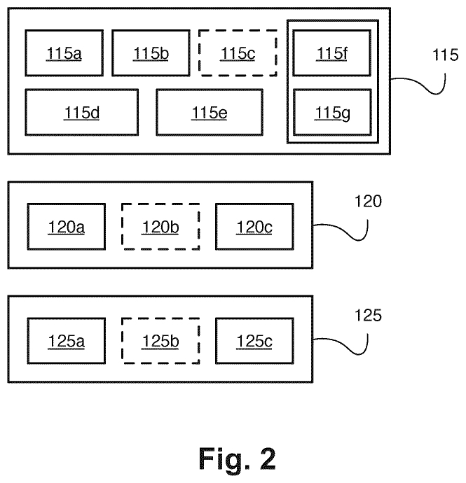

FIGS. 1 and 2 show a (first) block diagram illustrating selected functional building blocks of an exemplary computing platform 700 having a central computing unit (CCU) 105 and a related high-level communication structure for communication within the CCU 105 and with CCU-external communication nodes.

CCU 105 comprises (i) a computer module cluster 110 with a main computing module 115, one or more general-purpose computing modules 120, and one or more special purpose modules 125, (ii) a service module 135, and (iii) a connection device 130, such as a backplane (which may particularly be a passive backplane), for interconnecting the modules both among each other and with the service module 135.

The interconnections provided by the connection device 130 may particularly comprise power connections for exchanging power, such as electrical power P, data connections (e.g., Ethernet, PCI, or PCIe) for exchanging data D, control connections (e.g., I2C) for exchanging control information C, alarm connections for exchanging alarm information A, and power management connections for exchanging power management information I.

In the example of FIG. 1, the CCU-external communication nodes comprise a first endpoint cluster 140 which is optically connected, for example via a fiber communication link 0, to CCU 105, a second endpoint cluster 145 that connected via a wireless communication link W, e.g., a Bluetooth, WLAN, ZigBee, or cellular mobile connection link, to CCU 105. A third endpoint cluster 150, which may particularly be or comprise a zonal hub for interconnecting the CCU 105 to further endpoints 330, may be connected by a cable connection. A fourth endpoint cluster 155 may be connected to CCU 105 via a separate intermediate wireless transceiver 160.

Furthermore, two or more of the endpoint clusters 515 may be directly linked with each other by communication links that do not involve CCU 105, as exemplarily illustrated with a wireless communication link W between the third endpoint cluster 150 and the fourth endpoint cluster 155. Each of the endpoints 330 is a node within the communication network being formed by the communications links connecting the endpoints 330 directly or indirectly to CCU 105 or among each other. Particularly, an endpoint 330 may be or comprise one or more of an actuator 715, a sensor 720, and an intermediate network node, e.g., hub, for connecting multiple other endpoints 330.

The term “endpoint cluster” 515, as used herein, refers to a set of endpoints 330 which are connected directly or indirectly via respective communication links to a same network node so that all of them can exchange information with that common node. Typically, this common node will have some sort of hub functionality, i.e., serve as an intermediate node in a communication link between other nodes being connected to it.

CCU 105 further comprises (not shown in FIGS. 1A and 1B) a communication switch and a power supply system. These building blocks of CCU 105 will be discussed further below with reference to FIGS. 2 to 5.

Referring now to FIGS. 2, which illustrates the main computing module 115, the general-purpose computing modules 120, and the special purpose modules 125 of the computing module cluster 110 of FIG. 2 in more detail. Turning first to main computing module 115, which comprises within the same module and thus in co-location at least a first computational entity (CE) 115a, a separate second computational entity 115b and optionally one or more further CEs 115c. All of these CEs are autonomous and independent from each other in the sense that all of them have comparable, ideally identical, computing capabilities and their respective own individual memory, so that each of these CEs can serve as a replacement for a respective other one of these CEs.

In the further discussion, for the sake of simplicity and without limitation, an exemplary case is considered where beyond the first CE 115a and the second CE 115b no further CEs 115c are present in the main computing module 115. Each of the first CE 115a and the second CE 115b may be embodied in a respective separate hardware unit, such as a semiconductor chip, e.g., a system-on-chip (SOC).

The first CE 115a and the second CE 115b are configured, e.g., by a respective software (computer program(s)), to work redundantly in such a way that they synchronously perform identical computing tasks to enable a proper functioning of the CCU 105 for as long as at least one of the first CE 115a and the second CE 115b is properly working. Accordingly, there is not only a redundancy among the first CE 115a and the second CE 115b in terms of a redundant hardware, but also in terms of the computing tasks they perform synchronously, such that if one of the first CE 115a and the second CE 115b fails (with or without pre-warning), the respective other one of these CEs can immediately step in and thus maintain the computing functionality of the main computing module 115 based on its own ongoing synchronous performance of the same computing tasks.

Now, before continuing with an explanation of the remaining building blocks of main computing module 115, reference is made to general-purpose computing module 120. It comprises at least one autonomous CE 120a and optionally one or more additional CEs 120b. Each of autonomous CEs 120a and additional CEs 120b is designed as general-purpose computing entity, i.e., as a computing entity which is designed to perform all kind of different computing tasks rather than being limited to performing only computing tasks of one or more specific kinds, such as graphics or audio processing or running an artificial neural network or some other artificial intelligence algorithm. Each of autonomous CEs 120a and additional CES 120b has its own memory and is independently from other CEs capable of autonomically performing computing tasks having been assigned to it.

In addition, each general-purpose computing module 120 comprises a respective individual fault management system (FMS) 120c, which is configured to detect malfunctions, such as hardware and/or software-based errors or defects, occurring within or at least with an involvement of general-purpose computing module 120. FMS 120c is further configured to communicate any such detected malfunctions to the main computing module 115 via the connection device 130 by means of alarm information A.

Turning now to special purpose module(s) 125, in contrast to general-purpose computing module(s) 120, special purpose module 125 is designed specifically to perform one or more selected tasks, such as computing tasks or communications tasks, and is generally less suitable or even incapable of performing general computing tasks like main computing module 115 and general-purpose computing modules 120. For example, one or more of special purpose module(s) 125 may be or comprise a graphics processing unit (GPU), a module being specifically designed to run one or more artificial intelligence algorithms, a neural processing unit (NPU), or an in-memory compute unit (IMCU) or a local hub module. Accordingly, a special purpose module 125 may particularly comprise one or more of such special CEs 125a and/or one or more communication interfaces 125b for establishing communication links, such as links to endpoints 330 or endpoint clusters 515. Each special CE 125a has its own memory and is independently from other CEs capable of autonomically performing computing tasks having been assigned to it.

In addition, also each of special purpose module(s) 125 comprises a respective special individual fault management system (SFMS) 125c, which is configured to detect malfunctions, such as hardware and/or software-based errors or defects, occurring within or at least with an involvement of the respective special purpose module 125. Each SEMS 125c is further configured to communicate any such detected malfunctions to the main computing module 115 via the connection device 130 by means of alarm information A.

While computing module cluster 110 may thus comprise one or more general-purpose computing modules 120 and/or one or more special purpose modules 125, and/or even other modules, it may, in a simple form, be implemented without such additional modules such that only main module 115 remains as a computing module. Particularly, it is possible to implement computing module cluster 110 or any one or more of its computing modules based on a set of interconnected chiplets as components thereof.

Returning now to main computing module 115, among all modules, this module takes-amongst other roles—the role of assigning tasks, including particularly computing tasks, to the various modules of the computing module cluster 110. This assignment process thus provides a resource coordination functionality 115d for the computing module cluster 110. First CE 115a and second CE 115b may thus be designated “master CEs” while the other CEs within general-purpose CE 120 and special purpose CE(s) 125 are at the receiving end of such task assignment process and may thus be designated “slave CEs”, as they have to perform the tasks being assigned to them by the master CE(s).

The assignment of tasks as defined by the master CE(s) is communicated to the slave CEs by means of message passing via the connection device 130, thus communicating, for example, corresponding control information C and/or data D.

Particularly, the resource coordination functionality 115d may comprise a process wherein the main computing module 115 receives periodic reports of major software operations (including parallel & sequential operations) on all CCU 105 processes (running on the set of CEs) and the current priority master CE assigns tasks between and towards the various CEs based on such reports (while the other master CE synchronously runs the same process, although its related task assignments will be discarded). Instead, or in addition, the assignment may depend on an amount of available energy that is currently available to power the CCU 105.

While such assignment may even include an assignment of computing tasks to the master CEs themselves, such assignment will address both master CEs similarly so that both will then perform such self-assigned tasks synchronously, thus maintaining the fully redundant operation of both master CEs.

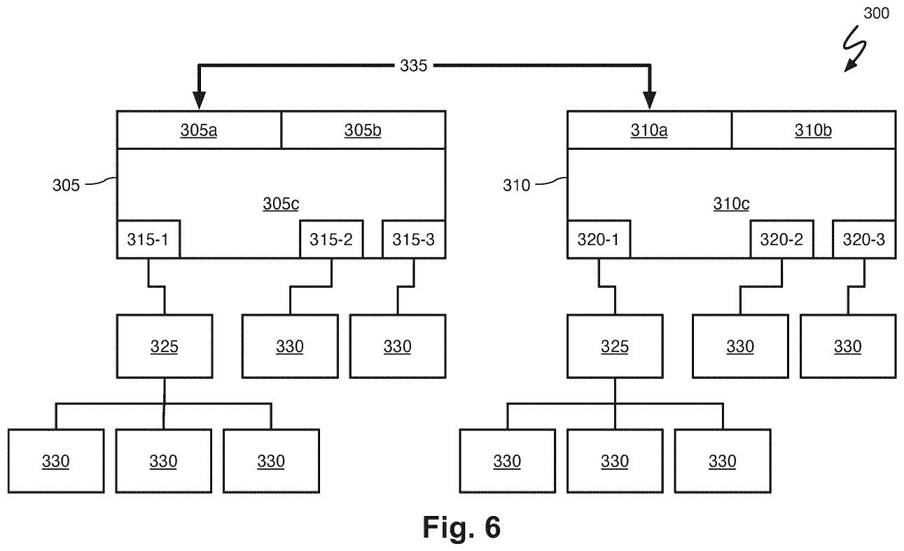

Overall, the set of CEs of the various modules, which are co-located, as will be explained in more detail below with reference to the exemplary embodiment of a CCU 105 in FIG. 6, thus forms a distributed computing system (DCS) in which computing tasks to be performed by the DCS as a whole can be variably assigned to different CEs within computing module cluster 110, and wherein such assignment is communicated by way of message passing among the involved CEs.

The main computing module 115 further comprises a central fault management system (CEMS) 115f which is configured to receive via alarm information A provided by one or more of the FMS 120c of the other modules or even from an own individual FMS (iFMS) 115g of the main computing module 115 itself, fault associated anomalies having been detected within the DCS. CFMS 115f is configured to categorize and classify such alarm information A and to initiate countermeasures, such as a reassignment of computing tasks from a defect CE or module to another module or in case of insufficient remaining computing power, a prioritization of the tasks such as to support the more important tasks at the cost of less important ones.

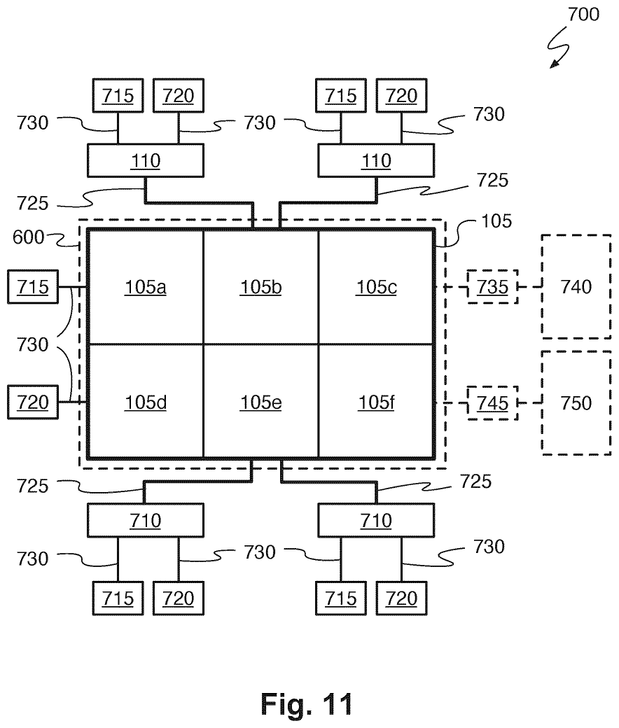

The main computing module 115 further comprises a safety management system (SMS) 115e that is configured to take decisions on and if needed initiate necessary safety measures (i.e., safe state escalation incl. real time scheduling) to bring the CCU 105 and/or a vehicle 800 (see FIG. 11) it helps control into a safe state. Accordingly, safety management system 115e may particularly rely as an input on the alarm information A being available from the CFMS 115f which in turn consolidates the alarm information A received from the various individual FMS 120c and iFMS 115g of the various modules of the CCU 105.

If, for example, the alarm information A (or some other information being available to SMS 115e indicates a loss of power in the power supply for CCU 105, SMS 115e might take a decision to use all remaining power for steering the vehicle 800 to the roadside while turning off the power supply to all non-essential systems of the vehicle 800. Such non-essential systems might for example relate to air conditioning or entertainment, and to such modules of the CCU 105 which are not needed for essential tasks for enabling the process of safely steering the vehicle 800 to the roadside. Such essential tasks might for example include turning on the warning lights and tasks related to the braking system of the vehicle 800.

The central fault management system 115f and the resource coordination functionality (RCOS) 115d are for example implemented in a redundant manner in multiple instantiations, such that a failure of one instantiation can be compensated by another instantiation. Particularly, each of the first CE 115a and second CE 115b may have an associated different one of such instantiations so that each of first CE 115a and second CE 115b is autonomous and has its own autonomous CEMS 115f and own autonomous RCOS 115d.

The RCOS 115d, SMS 115e, CFMS 115f, FMS 120c and iFMS 115g may particularly be implemented, individually or jointly, in whole or in part, as one or more computer programs designed to run synchronously (in separated instantiations) on each of master CEs, i.e., on each of the first CE 115a and the second CE 115b, respectively. Hybrid implementations are possible too, wherein dedicated hardware is provided in addition to the one or more processors for running the software to enable a selective offloading of certain tasks, e.g., to a high-performance dedicated system-on-chip, SoC).

FIG. 2 illustrates, according to embodiments of the present solution, a second block diagram 200 showing more details of the functional building blocks of the CCU 105 of FIG. 1, with a focus on a redundant set-up thereof.

As already discussed above with reference to FIGS. 1 and 2, the computing module cluster 110 comprises within its main computing module 115 two or more master CEs, in the present example first CE 115a and second CE 115b. Accordingly, redundancy is available at the level of master CEs.

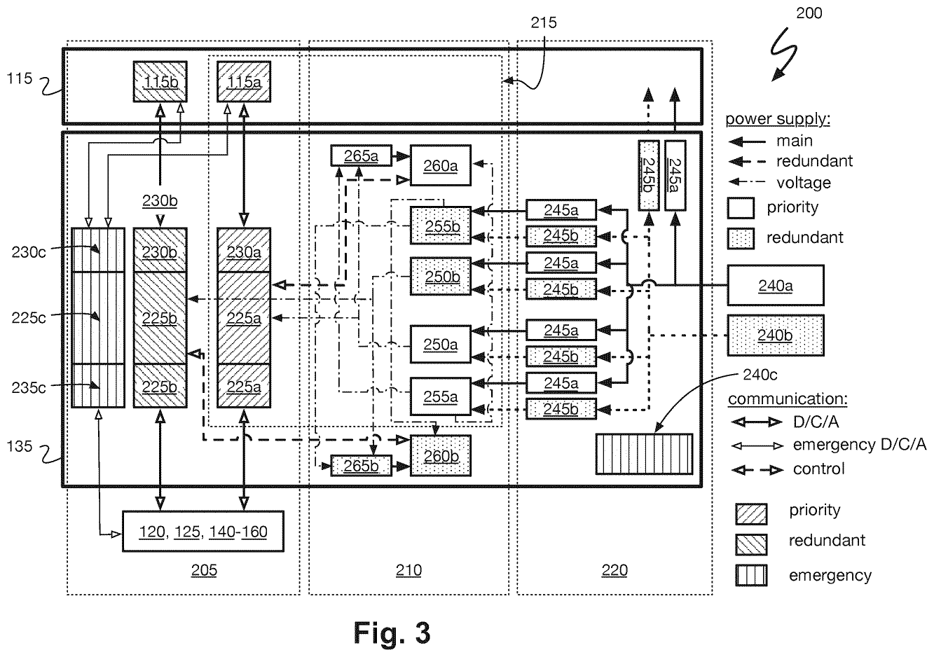

Furthermore, CCU 105 comprises a communication switch which in turn comprises a plurality of mutually independent switching fabrics. In the example of FIG. 3, there are two independent and autonomously operating (main) switching fabrics, namely a first switching fabric 225a and a second switching fabric 225b, and a third switching fabric 225c for emergency situations. All switching fabrics 225a, b, c are provided within service module 135. Each of the first switching fabric 225a, the second switching fabric 225b, and the third switching fabric 225c comprises hardware for variably connecting multiple different nodes of a network, such as nodes of a computer network, to variably exchange data D therebetween. In the present example, the network comprises as nodes the modules of computing module cluster 110 and the various endpoints 330 or endpoint clusters 515 thereto, for example as illustrated in any one or more of FIGS. 1, FIGS. 7, 8 and 9.

Each of the (main) switching fabrics, i.e., the first switching fabric 225a and the second switching fabric 225b, is signal connected 730 to an associated one of the master CEs in main computing module 115, so that it can selectively switch flows of information between the respective master CE, i.e., the first CE 115a or the second CE 115b, and other nodes, such as nodes 120, 125 and 140 to 160, of the network. Specifically, the switching fabrics may be designed as switches conforming to the PCI Express (PCIe) industry standard (PCIe switch 325). The same applies to the third switching fabric 225c, although it may have a restricted connectivity. For example, it may be connected to only a true subset of the set of endpoints 330 and/or to only a true subset of the set of slave CEs 120a, 120b, 125a, or even to none of these CEs.

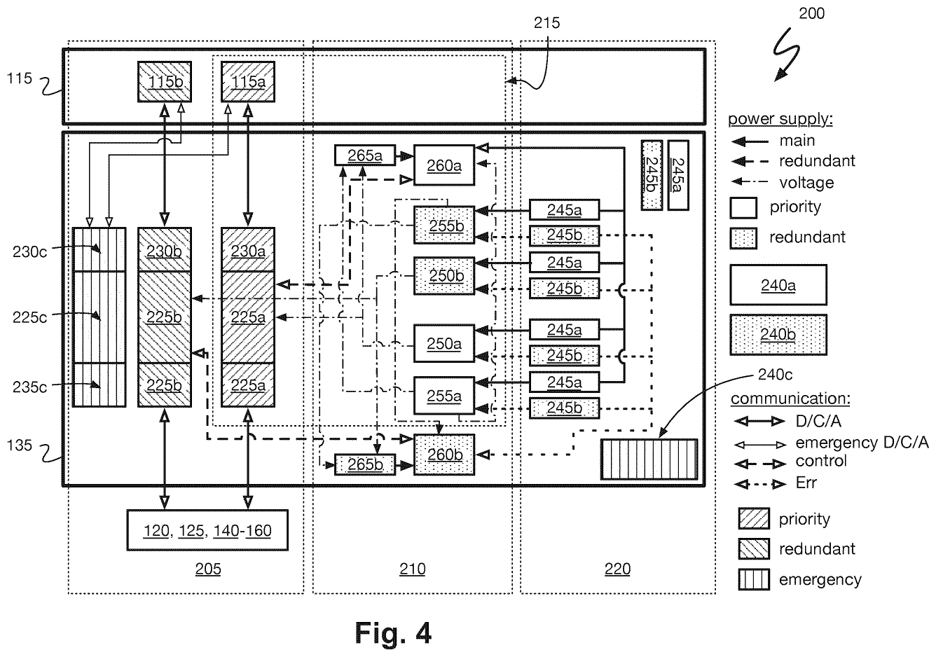

For security purposes, the network connections between the switching fabrics and other nodes of the network may be protected by one or more first security functions 230a, b at the CE side and/or one or more second security functions 235a, b at the endpoint 330 side, such as authentication, packet inspection, encryption, digital signatures, and/or obfuscation and may involve offloading to specified security devices. Particularly, the first security functions 230a, b and/or the second security functions 235a, b may be implemented as building blocks of the respective associated switching fabric, as illustrated in FIGS. 3 and 4, where authentication and packet inspection are provided in the first security functions 230a, b as a guarding function at the endpoint 330 side of the fabrics, while one or more of the second security functions 235a, b may be provided in each of security blocks at the respective CE side of the first switching fabric 225a, the second switching fabric 225b, and the third switching fabric 225c.

The main computing module 115 with the master CEs 115a and 115b and the switching fabrics 225a, 225b and 225c with their related security functions/blocks can be said to define together a computing task coordination domain 205 205 of CCU 105, wherein computing tasks can be assigned variably among the modules of computing module cluster 110. The CCU 105 may particularly be configured to fully enumerate all nodes of the network during a boot process and/or a reset process such that upon completion of these processes all nodes have a defined identity within the network, e.g., an assigned identification code by which they can be unambiguously identified within the network. The enumeration process may particularly be performed under the guidance of the communication switch and/or the main computing module 115.

In order to avoid any confusion, at each given point in time, only one of the master CEs is defined (e.g., by a related flag) as a current priority master CE, which means that the other entities of the CCU 105 will only “listen” to its commands (such as assignments of computing tasks) while ignoring any commands coming from any of the other master CEs. In FIG. 3, the first CE 115a is currently defined as current priority master CE while the second CE 115b is not.

This is indicated in FIG. 3 by hatching, wherein the current priority master CE, i.e., first CE 115a, and all other building blocks of the second block diagram 200, which are specifically associated with the current priority master are shown in “downward” hatching and the reference number attribute “a” (such as in “225a”), while the other master CE, i.e., second CE 115b, as well as all other building blocks of computing task coordination domain 205 which are specifically associated with the other master CE are shown “upward” hatching and the reference number attribute “b” (such as in “225b”).

If a malfunctioning of the current priority master CE or of a switching fabric being associated therewith is detected, the other/another master CE, which is determined to work properly (e.g., by a build-in-self test), as the new priority master CE such that the new priority master CE takes over the role previously held by the malfunctioning current master CE. The same applies to the associated switching fabrics. If, for example, current priority master CE (in the present example first CE 115a) and/or its associated first switching fabric 225a are found to be malfunctioning, e.g., due to a hardware defect, then previously redundant master CE, i.e., the second CE 115b and its associated second switching fabric 225b are determined to now have priority and take-over the roles previously taken by the first CE 115a and its associated first switching fabric 225a.

Furthermore, in an emergency situation, such as when in addition also the other switching fabric, i.e., the second switching fabric 225b (now acting as new priority switching fabric), is found to be malfunctioning, the third switching fabric 225c may be determined to now get priority and take-over the role of the previous priority switching fabric 225a or 225b. If the third switching fabric 225c has a restricted connectivity, as discussed above, then all non-connected endpoints 330 and CEs will automatically be disconnected from the switching functionality of the service module 135 when the third switching fabric 225c takes over. In this way, the CCU 105 can focus on emergency tasks, even without having to involve the resource coordination functionality 115d.

Turning now to the power supply system for CCU 105, there are two (or more) redundant, mutually independent power sources, in the present example a first main power source 240a and a second main power source 240b, each of which is individually capable of providing enough power, such as electrical power P, to the CCU 105 to support all of its functions, at least under normal operating conditions. In normal operation, all of these power sources are configured to operate simultaneously to jointly provide a redundant and thus highly-reliably power supply to the CCU 105. The power sources 240a and 240b may be components of CCU 105 itself or may be external thereto, e.g., as CCU-external vehicle 800 batteries, as shown in FIG. 3.

Furthermore, the CCU 105 may comprise, e.g., in its service module 135, a further power source such as an emergency power source 240c. The emergency power source 240c may particularly be designed as a mere interim power source with a more limited capacity than each of the first main power source 240a and the second main power source 240b, but enough capacity to power at least the third switching fabric 225c, when the latter is in operation.

To further support the redundancy concept 201, on which CCU 105 is based, for each of the main power sources there is an individual independent power network (cf. “main” path and “redundant” path, respectively in FIGS. 3 and 4) for distributing the power provided by the respective main power source among the physical components of CCU 105 which have a need to be powered, including-without limitation-all CEs in each computing module and all switching fabrics. Specifically, each main power source and its respective power network is configured to simultaneously power all switching fabrics such that full redundancy is achieved and operation of CCU 105 can be maintained even in cases where one switching fabric or one main power source fails.

Current limiters 245a, b may be provided within the power networks to ensure that any currents flowing in power lines of the CCU 105, particularly in its service module 135, remain below a respective defined current threshold in order to avoid any current-based damages or malfunctions which might occur if current levels were to rise beyond such respective thresholds. The power networks and optionally also the main power sources (if part of the CCU 105) define a power supply domain 220 of CCU 105, which provides a high degree of reliability due to its redundant set-up.

The various hardware components of CCU 105 might have different voltage requirements for their power supply. Accordingly, the power system of CCU 105 may further comprise various redundantly provided, voltage generation units each being configured to provide a same set of different power supply voltage levels as needed and distributed to the switching fabrics 225a, 225b, 225c through the backplane. For example, a first voltage level may be at 3,3 V for powering a first set of devices, such as Ethernet to PCIe bridges of CCU 105, while a second voltage level may be at 1, 8 V for powering a second set of devices, such as microcontrollers and NOR Flash memory devices of CCU 105, a third voltage level may be at 0,8V for powering a third set of devices, such as DRAM memory devices of CCU 105, etc., Particularly, this allows a control coordination domain 210 of CCU 105 to control the voltage levels of the entire service module 135 as well as those generated within the computer module cluster 110 itself.

In addition, CCU 105, namely its service module 135, comprises two or more mutually redundant controllers 260a, b, e.g., microcontrollers, for controlling selected functions of service module 135. Particularly, controllers 260a, b may be configured to control, using power management information I, a power supply for the communication switch with switching fabrics 225a and 225b.

Specifically, there may be one or more first voltage generation units 250a, b and one or more second voltage generation units 255a, b, and they may all generate a same set of voltages. Each first voltage generation unit 250a, b provides the full set of voltage levels to an associated one of the first switching fabric 225a and the second switching fabric 225b, while each second voltage generation unit 255a, b provides the same full set of voltage levels to an associated one of controllers 260ab. Each controller 260a, b compares the voltage set delivered by its associated first voltage generation unit 250a, b to its associated switching fabric with the set received from said second voltage generation unit 255ab. Normally, these voltage sets should match. If the controller 260a, b determines, however, that the voltage level sets do not match, a problem is detected and a reaction may be initiated by the controller 260a, b, e.g., the switching off of one or more components.

All first voltage creation units and second voltage generation units 255a, b individually generate the set of output voltages based on a load sharing or voting process in relation to the power supplied simultaneously from the first main power source 240a and the second main power source 240b. For example, power supply sharing may be applied, when both main power sources are found to be stable, while voting may be applied in case where power supply by one of the main power sources is unstable.

Service module 135 comprises a monitoring functionally which is also redundantly implemented in at least two independent instantiations, e.g., first hardware components and second hardware components. The monitoring may particularly comprise a monitoring of one or more of a current monitoring, voltage monitoring and clock monitoring. Such monitoring may particularly relate to the power outputs of the first voltage generation units 250a, b and the second voltage generation units 255ab. The monitoring results are provided to the controllers 260a, b where they are analyzed and control information (signals) C defining a reaction to the results of the analysis and/or in case of a detected malfunction alarm information (signals) A may be issued and communicated to relevant other components of CCU 105, such as the CFMS 115f in the main computing module 115 and/or some other safety function of CCU 105, if any. The CEMS 115f can thus react accordingly, such as by reassigning current or upcoming computing tasks to CEs that are not affected by the detected malfunctioning.

The controllers 260a, b, the first voltage generation units 250a, b and the second voltage generation units 255a, b, and the monitoring units 265a, b thus may be designated as a control coordination domain 210 of the service module 135. In fact, grouping now separately the components of the priority path (i.e., being associated with the current priority master CE) on the one hand and the components of the redundant path (i.e., being associated with the currently other master CE) on the other hand, for each master CE a respective associated fabric power coordination domain 215 may be defined that comprise the components of the associated group. In FIG. 3, only one of these fabric power coordination domains 215 is drawn (dashed frame).

As illustrated in FIG. 4 (the power supply paths are not shown here to reduce the complexity of the drawing), the current limiters 245a, b may particularly be equipped with a diagnostic output functionality so as to generate and output diagnostic data based on the operation of the respective current limiter 245a, b and/or characteristics of the power it receives or provides. The diagnostic data can then be provided to the controllers 260a, b for further analysis and for initiating adequate reactions, e.g., changing the priority from one master CE and its associated switching fabric to the other master CE and its associated switching fabric, if the diagnostic data indicates a failure or malfunctioning of one or more components of the CCU 105 that may affect a proper functioning of the current priority master CE and/or its associated switching fabric.

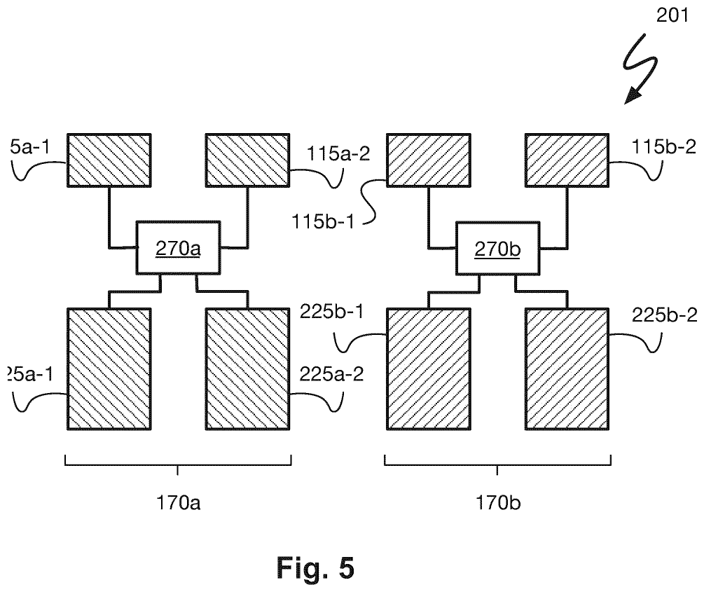

As shown in FIG. 5, the set-up illustrated in FIGS. 3 and 4 may be further enhanced by adding a further level of redundancy beyond the fundamental redundancy provided by a redundancy concept 201 defining two or more pairs 170a, b, each having an associated master CE and an associated switching fabric, as discussed above. Said further level of redundancy is based on creating redundancy within such a pair 170a, b by providing the master CE and/or the switching fabric of the pair 170a, b redundantly (i.e., in multiple instantiations) and further providing per such pair 170a, b a configuration switch 270a, b for switching between different configurations of the pair 170ab.

Accordingly, if a redundantly provided master CE and/or a redundantly provided switching fabric within a given pair 170a, b fails, the pair 170a, b as a whole is still operable because of the remaining one or more other master CE(s) and/or switching fabric(s), respectively. The priority concept discussed above for the fundamental redundancy between pairs 170a, b may be adopted similarly for the further redundancy level within a given pair 170ab. Accordingly, if a pair 170a, b has multiple redundant instantiations of master CEs, such as a first instantiation of the first master CE 115a-1, a second instantiation of the first master CE 115a-2, a first instantiation of the second master CE 115b-1, and a second instantiation of the second master CE 115b-2, these instantiations may be operated so as to simultaneously perform the same computing tasks while one of the first CE 115a and the second CE 115b is defined as a priority master CE of that pair 170ab. The same applies to the switching fabrics per pair 170a, b, when a pair 170a, b has multiple instantiations per switching fabric, such a first instantiation of the first switching fabric 225a-1, a second instantiation of the first switching fabric 225a-2, a first instantiation of the second switching fabric 225b-1, and a 2nd instantiation of the second switching fabric 225b-2.

By way of example, FIG. 5 illustrates two separate ones of such pairs 170ab. Unless such pair 170a, b consists of a single master CE, (e.g., a single first instantiation of the first master CE 115a-1) and a single switching fabric (e.g., the first instantiation of the first switching fabric 225a-1) (“I-shape”), it comprises an own configuration switch 270a, b and either two (or more) associated master CEs, such as two or more instantiations of the first CE 115a or the second CE 115b, or two (or more) associated switching fabrics, such as two or more instantiations of the switching fabrics. The configuration switch 270a, b is operable to variably switch between at least two different possible configurations of the respective pair 170ab.

Exemplary shapes per pair 170a, b are: (i) multiple instantiations of master CEs, e.g., instantiations of the first CE 115a and a single switching fabric 225a-1 (or 225b-1) (“Y-shape”); (ii) a single master CEs 115a-1 (or 115b-1) and multiple switching fabrics 225a-1 and 225a-2 (or 225b-1 and 225b-2) (“inverted Y-shape”); and multiple instantiations of master CEs 115a-1 and 115a-2 (or 115b-1 and 115b-2) and multiple instantiations of switching fabrics 225a-1 and 225a-2 (or 225b-1 and 225b-2) (“X-shape”). The pairs 170a, b may have a same or a different shape in general or at a given point in time. For example, a first pair 170a may have a Y-shape and a second pair 170b may at the same time have an X-shape. If a pair 170a, b has a shape other than the I-shape, it can be configured using its associated configuration switch 270a, b, particularly based on the operational state of its components, such as error-free operation or malfunction/failure. If, for example, the first pair 170a has an X-shape or an inverted Y-shape, and a failure of the second instantiation of the first switching fabric 225a-2 is detected, the first configuration switch 270a can be (re-) configured so that it now connects the (error-free) second instantiation of the first switching fabric 225a-2 to the current priority master CE of the pair 170a, b, e.g., to the first instantiation of the first master CE 115a-1.

Referring now to FIG. 6, which illustrates an exemplary conventional classical strictly hierarchical communication scheme 300 according to the standardized PCI Express (PCIe) communication technology, for communication between different nodes of a PCIe network, including, in particular, two different computing entities, such as a first central processing unit 305 (CPU) a second CPU 310.

The first CPU 305 comprises a first management functionality 305a, e.g., for scheduling computing tasks, a first processing functionality 305b for performing the scheduled computing tasks, and a PCIe first PCIe root complex 305c with three first PCIe root ports 315 (315-1, 315-2 and 315-3).

Similarly, CPU 310 comprises a second management functionality 310a, e.g., for scheduling computing tasks, and a second processing functionality 310b for performing the scheduled computing tasks, and a second PCIe root complex 310c with three second PCIe root ports 320 (320-1, 320-2 and 320-3).

All communication flows between such a CPU, e.g., the first CPU 305, and any endpoint 330 in a PCIe network being associated with the CPU have to go through the first PCIe root complex 305c using one or more of its first PCIe root ports 315 (315-1, 315-2 and 315-3). In addition to PCIe endpoints 430, there may be intermediate hubs in the PCIe network, such as one or more PCIe switches 325.

Accordingly, each of the first CPU 305 and the second CPU 310, respectively, has an own communication hierarchy including an own address space and/or clock domain for communication between any two nodes of its PCIe network, so that due to the hierarchy, every communication between two nodes of the same network must necessarily pass through the root complex of the associated CPU.

Communication between nodes of different communication hierarchies is enabled via an inter-CPU communication link 335 running between the first CPU 305 and the second CPU 310. Accordingly, if a first endpoint 330 being located in the communication hierarchy of the first CPU 305 needs to communicate with a second endpoint 330 being located in the communication hierarchy of the second CPU 310, then the communication path has to run
from the first endpoint 330 upstream through the communication hierarchy of the first CPU 305
through the first root complex with a relevant first PCIe root port 315,
through the first management functionality 305a of the first CPU 305,
then further over the inter-CPU communication link 335 to the second CPU 310, and
there in a downstream direction through its second management functionality 310a,
its second root complex 310c and a relevant second root port 320 thereof,
and, finally, to the second endpoint 330.

Accordingly, because the endpoints 330 of different communication hierarchies are isolated from the CPU of each respective other communication hierarchies, such a communication is not very efficient and may particularly suffer from a high latency.

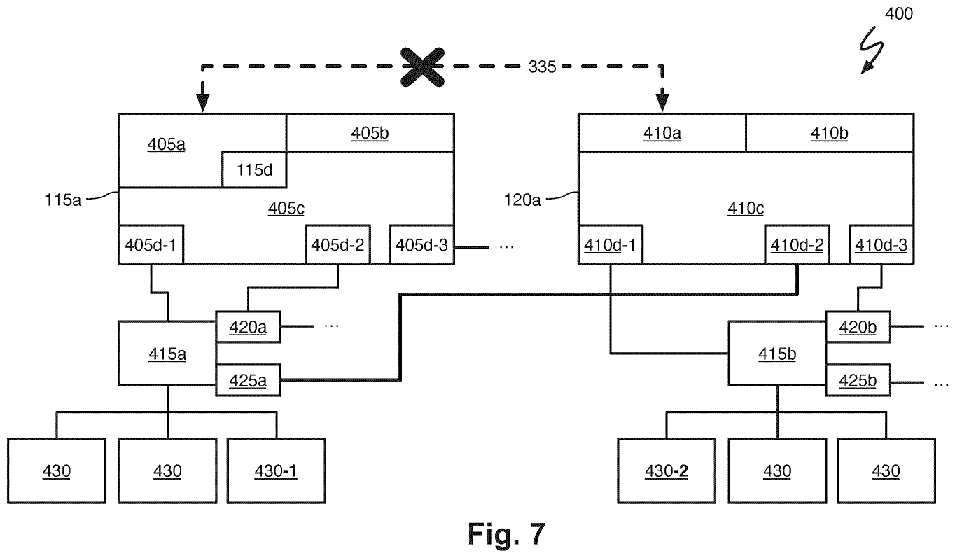

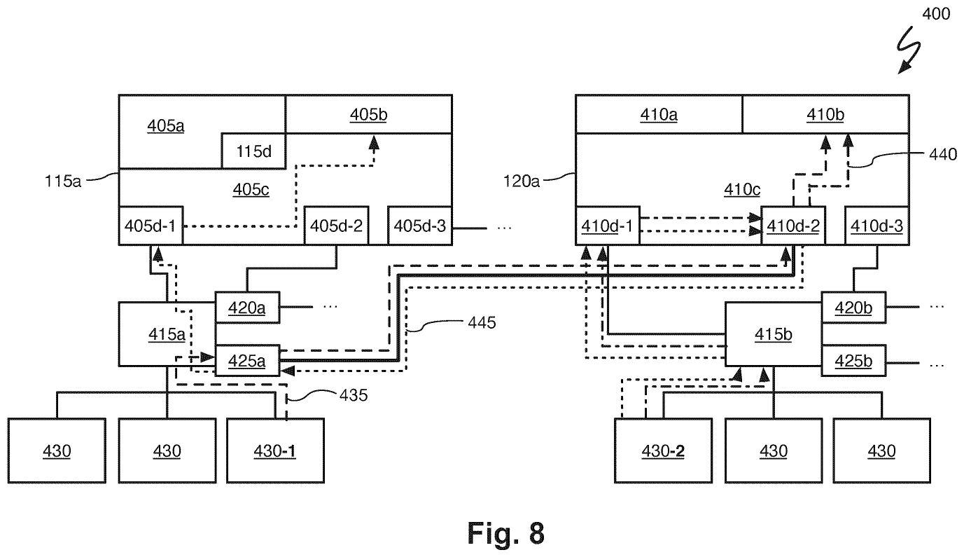

In contrast to the conventional approach of FIG. 6, embodiments of the present solution may implement an adapted PCIe communication scheme 400, as illustrated in one example in FIGS. 7 and 8. Also in this exemplary adapted PCIe communication scheme 400, there are two PCIe hierarchies, each having its own address space and a respective first PCIe single root complex 405c and second single root complex respectively. In the adapted PCIe communication scheme 400, the first CPU 305 of FIG. 6 is replaced by a master CE, e.g., the first CE 115a of FIG. 1B, and the second CPU 310 is replaced by a slave CE, e.g., the slave CE 120a of FIG. 3.

The first CE 115a (master CE) comprises a management functionality 405a, a processing functionality 405b, and the first single root PCIe root complex 405c with three PCIe root ports 405d (405d-1, 405d-2, and 405d-3). Similarly, slave CE 120a comprises a further management functionality 410a, a further processing functionality 410b, and the second PCIe single root complex 410c with three further PCIe root ports 410d (410d-1, 410d-2 and 410d-3), and resource coordination system block 415d comprising the resource coordination functionality (RCOS) 115d. All nodes of the adapted PCIe communication scheme 400 share a common clock, i.e., they are in a same clock domain.

In each communication hierarchy, there is a hierarchy-related PCIe switch 415a, b having one or more first Non-transparent PCIe Bridges (NTB) 420a, b for connection with the associated CE and one or more second Non-transparent PCIe Bridges (NTB) 425a, b for direct or indirect connection with one or more PCIe endpoints 430 or the respective other communication hierarchy, namely its root complex. The inter-CPU communication link 335 of FIG. 6 has now become obsolete and can be dispensed with.

Referring now particularly to FIG. 8, three exemplary communication paths are shown which are enabled by the adapted PCIe communication scheme 400.

A first communication path 435 enables a communication between a first selected PCIe endpoint 430-1 in the hierarchy of the first CE 115a serving as master CE and autonomous CE 120a serving as slave CE, specifically its further processing functionality 410b. The first communication path 435 runs from the first selected PCIe endpoint 430-1 to the corresponding first PCIe switch 415a in the same hierarchy and from there over a second NTB 425a to further PCIe root port 410d (specifically: root port 410d-2) of the second PCIe single root complex 410c of the other CE, namely slave CE 120a, from where it finally runs to further processing functionality 410b.

A second communication path 440 enables a communication between a second selected PCIe endpoint 430-2 in the hierarchy of slave CE 120a and the further processing functionality 410b of slave CE 120a. Accordingly, the second communication path 440 remains within a same hierarchy from the second selected PCIe endpoint 430-2 to corresponding second PCIe switch 415b to further PCIe root port 410d (specifically: root port 410d-1) and from there through further PCIe root port 410d (specifically: root port 410d-2) to its further processing functionality 410b, i.e., that of slave CE 120a, like in the conventional case of FIG. 6.

A third communication path 445 enables a communication between the second selected PCIe endpoint 430-2 in the hierarchy of slave CE 120a and another selected PCIe endpoint 430 in the hierarchy of master CE 115a. The third communication path 445 runs from the second selected PCIe endpoint 430-2 to corresponding second PCIe switch 415b in the same hierarchy to further PCIe root port 410d (specifically: root port 410d-1) of the second PCIe single root complex 410c of slave CE 120a and from there to further PCIe root port 410d (specifically: root port 410d-2) from where it reaches over NTB 425a the corresponding first PCIe switch 415a, from where it finally proceeds to processing functionality 405b.

All of these communication paths, particularly the first and the third path which interconnect different hierarchies, can be managed by the management functionality 405a of master CE 115a. The adapted communication scheme 400 therefore uses NTBs to enable “direct” point-to-point communication between distributed locations within the same clock domain, including in different hierarchies, while the communication managed, paths are particularly configured, centrally.

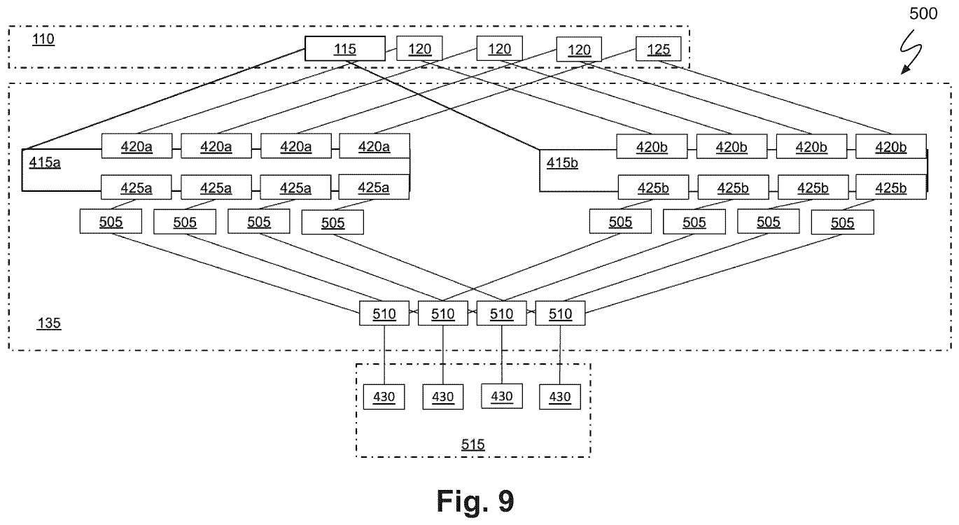

FIG. 9 illustrates, according to embodiments of the present solution, a third block diagram 500 showing more details of an exemplary CCU 105, particularly of its communication switch with service module 135. This CCU 105 has a computing module cluster 110 comprising a main computing module 115, three general-purpose computing modules 120, and a single special purpose module 125, each of the respective kind described above in connection with FIGS. 1 and 2.

Each of the modules of computing module cluster 110 is linked to two hierarchy-related PCIe switches 415ab. Each of these hierarchy-related PCIe switches 415a, b is equipped with a number of first NTBs 420a, b at the CE side and a number of second NTBs 425a, b at the PCIe endpoint 430 side. Accordingly, so far this setup is similar to that of FIGS. 7/8, albeit optionally with a different number of NTBs.

In addition, the CCU 105 of third block diagram 500 comprises for one or more, particularly all endpoint-side second NTBs 425a, b a respective conversion bridge 505 for performing a conversion between different communication technologies used in a related communication path running through the respective NTB. For example, such a conversion bridge 505 might be configured to perform a conversion from an Ethernet communication technology to a PCIe technology. Specifically, in the example of FIG. 9, the conversion bridges 505 are configured to perform a conversion from an Ethernet communication technology at the endpoint-side to a PCIe technology at the CE-side of the NTB.

Thus, PCIe technology is used for the communication among the modules of computing module cluster 110 and with the corresponding first PCIe switches 415a and corresponding second PCIe switches 415b and toward the conversion bridges 505, while Ethernet technology is used to communicate between the conversion bridges 505 and the PCIe endpoints 430. The latter may particularly be arranged, spatially or by some other common property such as a shared functionality, address space, or clock, in an endpoint cluster 515 of PCIe endpoints 430. Between the bridges 505 and endpoint cluster 515 Ethernet switches 510 may be arranged to variably connect selected individual PCIe endpoints 430 to selected conversion bridges 505. The set of hierarchy-related PCIe switches 415a, b and conversion bridges 505 may particularly be realized within a single SoC or by means of a chiplet solution where the hierarchy-related PCIe switches 415a, b and conversion bridges 505 are distributed across multiple chiplets, each chiplet bearing one or more of these components.

Accordingly, each module of computing module cluster 110 is connected to each of the two switching fabrics, each switching fabric comprising a respective hierarchy-related PCIe switch 415a, b, various NTBs 420a/425a or 420b/425b, and a number of conversion bridges 505. In this way, the desired redundancy is achieved, where each PCIe endpoint 430 may be reached (and vice versa) via each of the communication fabrics and from any module of computing module cluster 110.

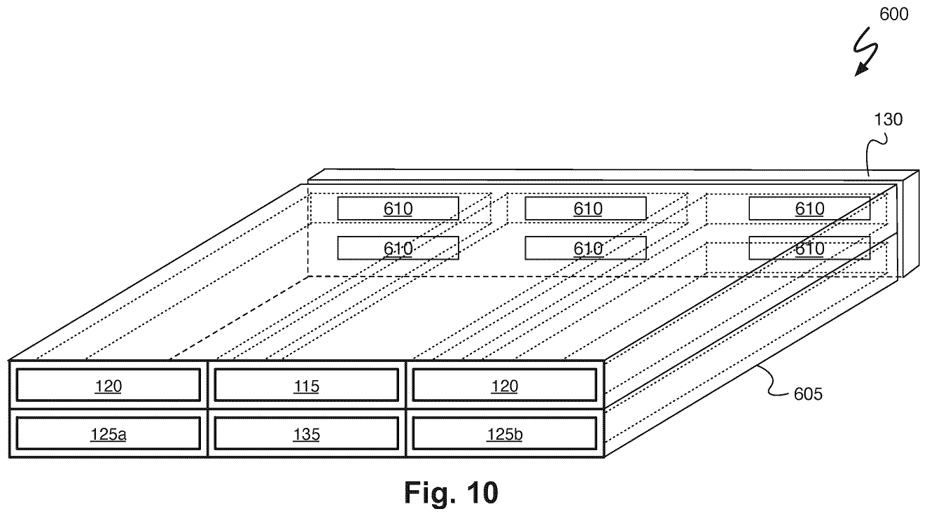

FIG. 10 illustrates, according to embodiments of the present solution, an exemplary housing 600 of an exemplary computing system, e.g., the CCU 105 of FIG. 1. Housing 600 comprises a rack-shaped housing structure 605 with a number of compartments, each for accepting, for example in a replaceable manner, a module of the CCU 105 such as a computing module of computing module cluster 110 or the service module 135. In the present example, there are six compartments (slots) arranged in a fabric and housing 600 in total (in co-location, specifically in a neighboring manner) the main computing module 115, two general-purpose computing modules 120, two special purpose modules 125, and the service module 135.

While a first end of the housing structure 605 comprises for each compartment a respective opening for inserting or extracting a module, the opposing end of the housing structure 605 comprises a connection device 130 that is configured to provide connections for exchanging one or more of power P, data D, control information C, alarm information A or power management information I among different modules.

The connection device 130 may particularly have a substantially planar shape and may thus be designated a “backplane”. Between the connection device 130 and the opposing rear faces of the modules there are one or more connectors 610 per module to provide the above-mentioned connections. Particularly, the connectors 610 may be designed as detachable connectors 610 so that the modules may be (i) inserted and connected simply by pushing them into their respective compartment until the associated one or more connectors 610 are connected and (ii) extracted and disconnected simply by pulling them from the compartment and thereby detaching the connections.

### Computing Platform

Referring now to FIG. 11, an exemplary embodiment of a computing platform 700 of or for a vehicle 800 (cf. FIGS. 3, 4) comprises a central computing unit (CCU) 105 having a modular design, wherein multiple different modules 105a through 105f are combined with in a common housing 600, e.g., of a rack type, to jointly define a computing device. Modules 105a through 105f may particularly coincide with modules 115, 120 (2x), 125a, 125b and 135, described above (cf. FIG. 10). The housing 600 and optionally further sections of the CCU 105 form its fixed part. In contrast thereto, at least one of the modules 105a through 105f, for example several thereof, are releasably connected in an exchangeable manner to the housing 600 so that they may be easily removed, based on releasable mechanical, electrical and/or optical connectors 610, such as to allow for a hardware-based reconfiguration, repair or enhancement of the CCU 105 by means of adding, removing or exchanging one or more of the modules in relation to the fixed part. Specifically, one of the modules, e.g., module 105b, may be an energy supply module for supplying energy to at least one, for example all the other modules 105a, and 105c to 105f. Energy supply module 105b may particularly belong to the fixed part of the CCU 105, but it is also conceivable for it to be releasably connected in an exchangeable manner to the housing 600 so that it may be easily removed, replaced etc.

The term “computing platform” 700, as used herein, may particularly refer to an environment in which a piece of software is executed. It may be the hardware or an operating system 1345 (OS), even a web browser and associated application programming interfaces, or other underlying software, as long as the program code is executed with it. Computing platforms 700 may have different abstraction levels, including a computer architecture, an OS, or runtime libraries. Accordingly, a computing platform 700 is the stage on which computer programs can run. It may particularly comprise or be based on multiple computers or processors.

The CCU 105 is designed to be used as a central computing entity of the computing platform 700 and is configured to provide on-demand computing to a plurality of different other functional units of the vehicle 800 based on a flexible software-defined resource and process management and/or control functionality of the CCU 105. Specifically, the CCU 105 may be designed to communicate with such other functional units over one or more, for example standardized high-speed communication links 725, such as one or more high-speed bus systems or several individual communication links, such as Ethernet links, e.g., for data rates of 10 Mbit/s or above. These high-speed communication links 725 may particularly be used to communicate one or more of data D, control information C, alarm information A, and power management information I, as discussed above, e.g., in relation to FIGS. 1, 2, 3, and/or 4.

Furthermore, the CCU 105 may comprise a multi-kernel operating system 1345 comprising a main kernel and multiple other kernels, wherein the main kernel is configured to simultaneously control at least two of the multiple other kernels while these are running concurrently.

Another one of the modules, e.g., module 105a (which may particularly coincide with a main computing module 115, as described above), may comprise a general-purpose computing device, e.g., based on one or more general-purpose microprocessors. Particularly, module 105a may be used as a main computing resource (e.g., main controller unit) of CCU 105 and is configured to allocate computing demands among multiple computing resources of CCU 105, including computing resources of other ones of the CCU's 105 modules.

Module 105c (which may particularly coincide with a special purpose computing module 125, as described above) may, for example, comprise a dedicated computing device, such as a graphics CPU (GPU) and/or a dedicated processor for running artificial intelligence-based algorithms, e.g., algorithms implementing one or more artificial neural networks. Furthermore, modules 105d, 105e and 105f may comprise other general-purpose or dedicated computing resources/devices and/or memory.

For example, module 105d may comprise a security controller for securing data and/or programs within the CCU 105 and restricted access thereto (module 105d may particularly comprise one or more of the first security functions 230a, b and/or second security functions 235a, b, as described above), and module 105e may comprise one or more interface controllers or communication devices for connecting CCU 105 to one or more communication links with other devices outside the CCU 105, such as actuators 715, sensors 720, or cluster hubs 710 (hubs) for aggregating/routing or splitting the signals from/to several actuators 715 and/or sensors 720 such as to form hub-centered clusters (e.g., one or more of endpoint clusters 515, 140, 145, 150, and 160 discussed above) and, each comprising several actuators 715 and/or sensors 720.

When such a cluster/hub concept is used, it may particularly be implemented based on a tree topology with various actuators 715 and/or sensors 720 being connected via related signal connections 730 to one or more cluster hubs 710 or multiple cascaded cluster hubs 710 to the CCU 105, e.g., to its module 105e. The cluster hubs 710, which may for example be denoted as “Zone Electric Controllers” 260a, b (ZeC) may specifically have a functionality of aggregating signals coming from different sources, such as actuators 715 and/or sensors 720 and may thereby be also configured to serve as a gateway between different communication protocols such as CAN, LIN, and Ethernet. Consequently, a lot of wiring can be saved, and the central computing approach can be used to provide the processing power for processing the signals from/to the actuators 715 and/or sensors 720, particularly for the purpose of controlling one or more functionalities of the vehicle 800 as a function of those signals. However, it is also possible to have a hub-less topology or a mixed topology, where some or all of the actuators 715 and/or sensors 720 are directly connected to the CCU 105 without any intermediate cluster hub 710.

The computing platform 700 may be designed as a multi-computing-layer platform and thus comprise multiple computing layers, e.g., (i) a first computing layer 740 for handling basic mobility functionalities of a vehicle 800, e.g., automobile, such as accelerating, decelerating and steering, (ii) a second computing layer for handling all kinds of other (e.g., digitalized) functionalities of the vehicle 800, such as driver assistance, infotainment or (other) comfort-related functionalities like climate control, and others, as described herein, and (iii) a third computing layer 750 handling vehicle 800 functionalities related to highly-automated or even autonomous driving, e.g., handling the signals of related sensors 720 for detection of objects or road markings etc. in a vehicle's 800 environment. The second computing layer may particularly be designed according to the FIG. 11 (but excluding the first computing layer 740 and the third computing layer 750 and related interfaces to the second computing layer (as described below), respectively.

In a multi-computing layer embodiment of the computing platform 700, one of the modules 105a-f of CCU 105 may further comprise or be configured to be linked to (i) a first interface unit 735 for connecting the second computing layer to the first computing layer 740 and (ii) a second interface unit 745 for connecting the second computing layer to the third computing layer 750 to exchange information therewith, respectively, in a controlled manner, e.g., according to one or more defined protocols.

Module 105f may, for example, comprise, inter alia, communication interface 125b for implementing an interface functionality to the third computing layer 750. In fact, it is also possible that module 105f itself comprises itself one or more computing units of the third computing layer 750 so that the second computing layer and the third computing layer 750, although being defined as separate computing layers with individual functionalities and structures, are then physically integrated in a same physical device, namely in the housing 600 and even, at least in part, within a same module of CCU 105.

Further details of multi-computing layer embodiments of the computing platform 700 are described in PCT/EP2023/055182 which is included herein in its entirety by way of reference.

### Vehicle

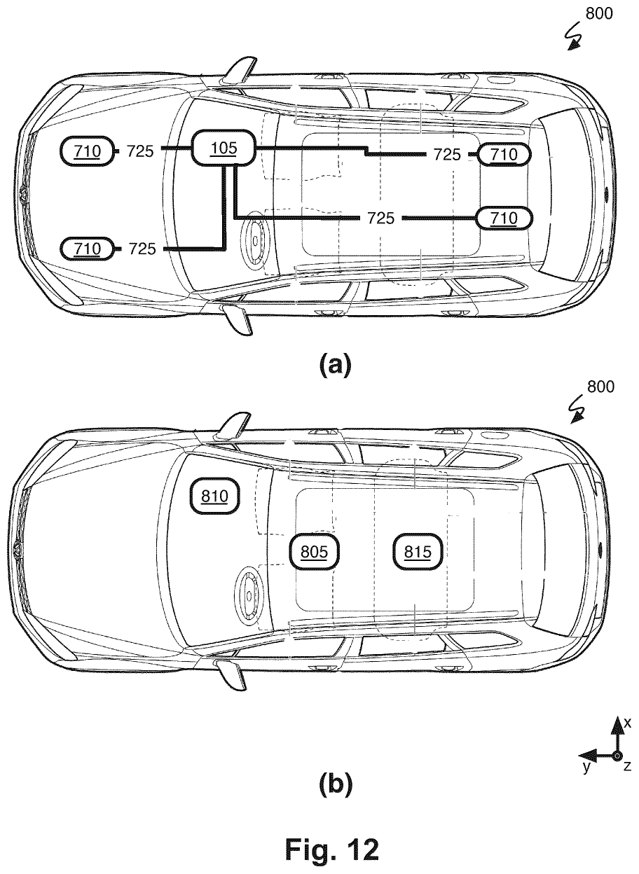

FIG. 12 illustrates an exemplary vehicle 800 particularly an automobile, comprising an exemplary computing platform 700 according to FIG. 11, including a CCU 105. The CCU 105 is configured to centrally control different functionalities (not shown) of the vehicle 800. For the sake of reducing complexity, only some elements of the computing platform 700 (particularly of its second computing layer) are illustrated while other elements are not explicitly shown, including in particular all actuators 715 and sensors 720 and in the case of a multi-computing layer embodiment, all elements of the first computing layer 740 and the third computing layer 750 and the first interface unit 735 and the second interface unit 745.

FIG. 12 (a) also shows several cluster hubs 710 of the second computing layer and related high-speed communication links 725 725 of the cluster hubs 710 to the CCU 105. Each of these hubs 710 may in turn be connected to a plurality of actuators 715 and/or sensors 720, as illustrated in more detail in FIG. 11.

While in principle, the CCU 105 might be located anywhere within vehicle 800, there are certain places, particularly in view of safety requirements and the need to make it easily accessible for enabling an easy removal and replacement of modules 105a through 105f into the housing 600 of CCU 105.

FIG. 12 (b) shows another simplified view of vehicle 800, wherein three different exemplary locations, i.e., a first location 805, a second location 810, and a third location 815 within the vehicle 800, that are particularly suitable for placing the CCU 105 within the vehicle 800 are identified. The first location 805 and the third location 815 are arranged on or near the (virtual) centerline of the vehicle 800 which centerline runs in the middle between the two side faces of the vehicle 800 along the latter's main extension dimension (y dimension). While the first location 805 is between two front seats, e.g., in a middle console, of the vehicle 800, the third location 815 is under a rear seat or seat bench in a second or third seating row. These central locations (at least in x and y dimensions) are particularly beneficial in view of safety and protection from damages or destruction in case of an accident. They are also easily accessible for purposes of maintenance, repair, or replacement, particularly when one or more of the modules 105a through 105f need to be extracted from the CCU 105, particularly from its housing 600.

The second location 810 810 is also highly accessible and is also protected well against crashes coming from almost any direction. This second location 810 810 may also be particularly suitable for entertaining wireless communication links W with communication nodes outside the vehicle 800, such as communication nodes of traffic infrastructure or of other vehicles 800 (e.g., for car-to-car communication), because due to its position close to the windshield, it will typically suffer less from electromagnetic shielding by the vehicle 800 itself.

Accordingly, CCU 105 may particularly be located in or near the glove compartment or in a central console of the vehicle 800, i.e., somewhere in or near a center of the passenger compartment of vehicle 800, such that CCU 105 is both well protected against external mechanical impacts, e.g., in the case of a vehicle 800 accident, and easily accessible.

Method of automatically evaluating a proper functioning of a computing system configured as a centralized on-board computing system

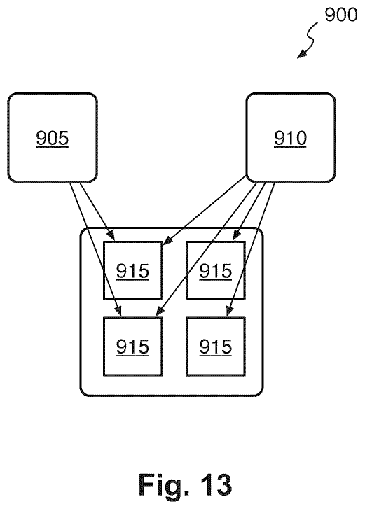

FIG. 13 illustrates a simple scenario 900 where conflicting hardware demands of different computer programs might occur in a computing platform 700, such as CCU 105. According to this scenario 900, a first computer program 905 comprising a first virtual machine and a second computer program 910 comprising a second virtual machine are simultaneously running on a same microprocessor having four computing cores 915. The first computer program 905 requires for its proper functioning two of the computing cores 915 while the second computer program 910 requires for its proper functioning all four computing cores 915. Accordingly, the number of required computing cores 915, i.e., the cumulative hardware demand of both computer programs, exceeds the number of available real computing cores 915 and consequently the two hardware demands are in conflict. Therefore, idle states, where one of the computer programs has to wait for the other computer program at times, i.e., when the cumulative hardware demand in terms of number of computing cores 915 exceeds four, cannot be safely avoided. Consequently, the overall performance of at least one of the computer programs is thus limited.

The following FIGS. illustrate some exemplary embodiments of the method of the first example aspect of the present solution.

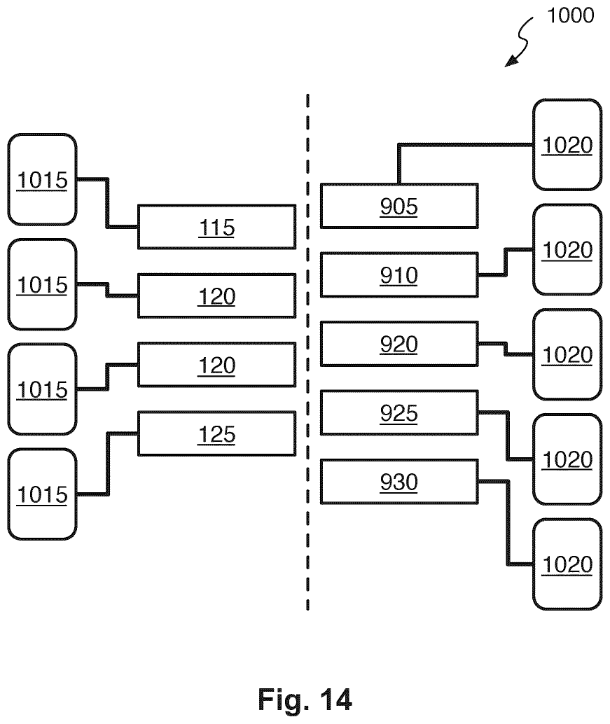

FIG. 14 illustrates, as elements of the method, an assignment scheme for assigning individual attributes to hardware entities and computer programs of a given computing system, like the one discussed above.

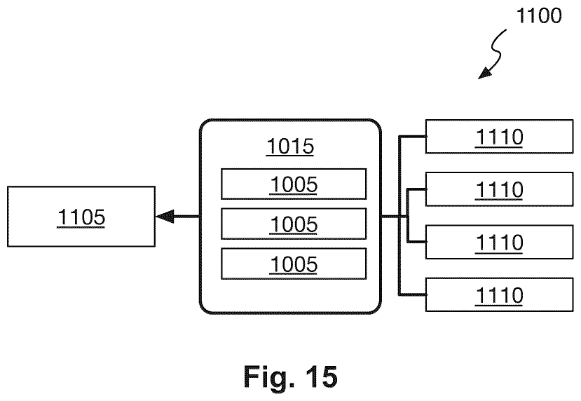

Specifically, according to the assignment scheme 100, individual property attributes 1005 are assigned to various hardware entities of the computing system and requirement attributes 1010 are assigned to various computer programs of the computing system. The hardware entities may particularly comprise one or more of the modules of the computing platform 700, e.g., of its computer module cluster 110, and may particularly be defined as abstract hardware entities 1105, as will be explained in more detail further below with reference to FIG. 15. Each hardware entity is assigned a first attribute set 1015 comprising one or more of individual property attributes 1005 characterizing the respective hardware entity and each computer program is assigned a second attribute set 1020 comprising one or more requirement attributes 1010 characterizing one or more hardware demands the respective computer program places on the hardware on which is to be run.

In the example of FIG. 14 the hardware entities relate to CCU 105 and comprise its main computing module 115, two instantiations of a general-purpose computing module 120 and one instantiation of a special purpose module 125. A respective individual first attribute set 1015 is assigned to each of these hardware entities, wherein these first attribute sets 1015 will typically be different among the hardware entities, at least between those hardware entities which differ in kind. Instead, or in addition, it is also possible to define the hardware entities based on a finer granularity, e.g., on the level of the individual CEs, such as the first CE 115a, the second CE 115b etc., of CCU 105.

On the software side, there are five different computer programs in the present example, namely the first computer program 905, the second computer program 910, a third computer program 920, a fourth computer program 925, and a fifth computer program 930. A respective individual second attribute set 1020 is assigned to each of these computer programs, wherein these second attribute sets 1020 will typically be different among the computer programs.

FIG. 15 illustrates a concept overview 1100 of an abstract hardware entity. According to this concept, an abstract hardware entity 1105 can be defined by a set of individual hardware properties, expressed as individual property attributes 1005, which can be shared by multiple different real instantiations 1110 of the abstract hardware entity 1105, e.g., different real instantiations 1110 being designed and/or manufactured by different providers. Accordingly, the set of individual hardware properties of the abstract hardware entity 1105 may be derived by combining the respective individual property attributes 1005 of the involved.

This is particularly important in the context of dual sourcing or even multiple-sourcing scenarios 900, where similar components, e.g., of a vehicle 800, are sourced from different suppliers while these components must be exchangeable among each other in the vehicle 800, i.e., one can be used instead of or as a replacement part of the other, their because relevant technical specifications, that is their sets of hardware properties (i.e., first attribute sets 1015), coincide or are at least compatible. Compatibility means in this context, that all of the real instantiations 1110 meet the same minimum requirements regarding their individual property attributes 1005, even if they are different among the or more of these instantiations. For example, if a minimum hardware property relating to available memory space is defined as 1 GB then different ones of the real instantiations 1110 are compatible in this regard, if each of them has at least 1 GB of available memory space, even if their memory space differs. Accordingly, a respective property attribute 1005 of the related abstract hardware entity 1105 could then be defined as “1 GB”. The first attribute set 1015, which characterizes a given abstract hardware component, comprises one or more individual property attributes 1005 which typically differ from each other.

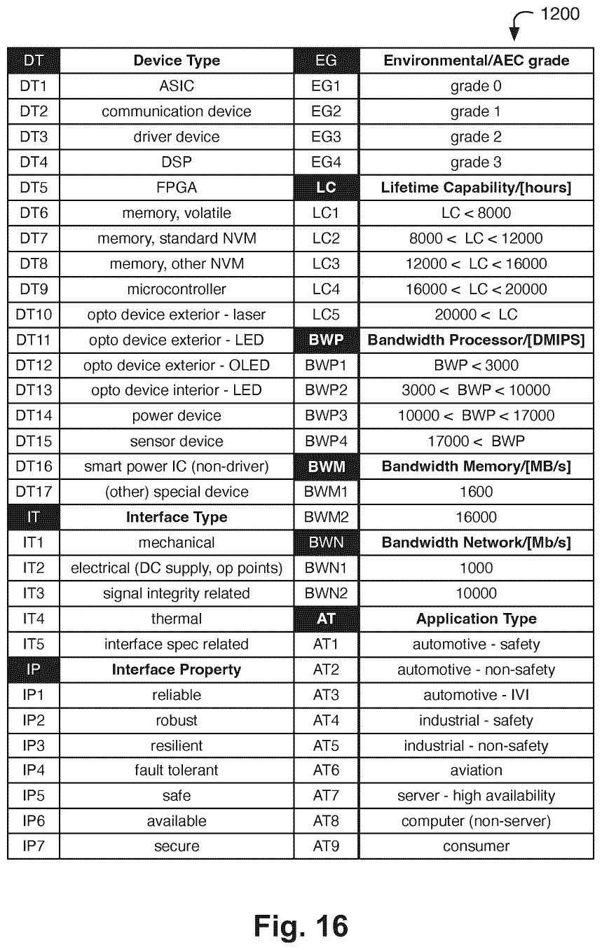

FIG. 16 shows a table 1200 defining various exemplary individual property attributes 1005, grouped in different property attribute 1005 categories. These property attribute 1005 categories comprise, amongst others, a category “Device Type (DT)”, a category “Interface Type (IT), and a category “Application Type (AT)”. Within each category, there can be one or more, typically multiple different property attributes 1005, such as “ASIC” or “digital signal processor, DSP” with the category “Device Type (DT)”. Each individual property attribute 1005 has a respective associated unique and computer-readable property identifier, e.g., “DT1”, “IT3”, “AT6”, etc., just to name a few.

Accordingly, each property attribute 1005 can be unambiguously identified and distinguished even by its property identifier alone. The individual property attributes 1005 of a same category may be considered as different “classes” of such category. Accordingly, the categories and their respective classes are organized in a hierarchical order which is also reflected in the identifiers, e.g., identifier “DT1” is associated with the first class with category “Device Type” having the top-level identifier “DT”.

Consequently, a hardware entity, particularly an abstract hardware entity 1105, may be characterized by the set of its associated property identifiers, which may particularly be concatenated to define a string that can serve as a unique identifier ID of the hardware entity as a whole. An example is provided below:

$$ID = pcb \text{.1} . comp \text{.1} . DT 9. EG 2. LC 2. BWP 4. AT 1. IT 5.1 . IP 5. CAN . D . IT 5.2 . PCIe . IP 5. B$$

$$Hardware - Board = pcb \text{.1}$$

$$Considered device = comp \text{.1} ( component no . 1 ) \\ Device type = DT 9 ( μ C - microcontroller )$$

$$Environmental capability = EG 2 ( AEC - Q 100 grade 1 ) \\ Component specified lifetime = LC 2 ( > 8000 ; < 12000 hours ) \\ μ C - Performance = BWP 4 ( > 17000 DMIPS ) \\ Application type = AT 1 ( automotive safety ) \\ Interface type = IT 5 ( specification ) \text{.1} ( 1 st interface ) . IP 5 ( safety ) . CAN ( CAN bus ) . D ( ASIL D ) \\ Interface type = IT 5 ( specification ) \text{.2} ( 2 nd interface ) . IP 5 ( safety ) . PCIe ( PCIe bus ) . B ( ASIL B )$$

Generally, first attribute sets 1015 and second attribute sets 1020 may be stored in any suitable data structure, such as a string (see above), a matrix, a table 1200, a data set of a database D, etc.,

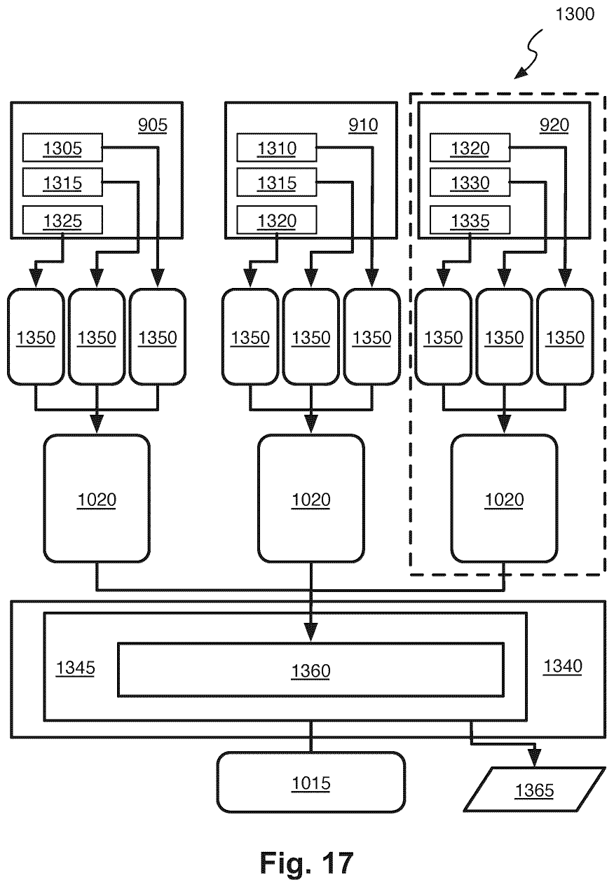

FIG. 17 illustrates a first embodiment 1300 of the present method, wherein a computing system is evaluated that comprises three different computer programs, namely a first computer program 905, a second computer program 910, and a third computer program 920 which, at least at times, need to run concurrently on a same shared computing platform 700 of the computing system. The computer programs may particularly be application-level programs and/or programs belonging to lower software layers, such as an operating system 1345 or a virtual machine environment (e.g., a hypervisor).

The computing platform 700 may particularly conform with any one or more of FIGS. 1 to 12 and may thus particularly comprise a CCU 105. The method comprises assigning first attribute sets 1015 to relevant hardware entities of the computing platform 700, as discussed above, e.g., in relation to FIGS. 14 to 16.

Furthermore, the method comprises assigning a respective second attribute set 1020 to each of the three computer programs, wherein each of the second attribute sets 1020 comprises one or more requirement attributes 1010 representing individually or jointly one or more specific hardware demands that the respective computer program requires for its proper execution on the computing platform 700. Instead, it is also possible for a group of two or more computer programs to share a combined second attribute set 1020 defining hardware demands required for the group of computer programs as a whole, e.g., for their simultaneous execution. The latter is particularly useful if their simultaneous operation is a regular use case.

One or more of the computer programs may be designed, at least partially, in a modular manner such that each such program comprises two or more program modules. Specifically, these program modules may be designed for reuse by multiple ones of the computer programs. Each program module has one or more individual module-level requirement attributes 1010 being assigned to it, which represent individually or jointly one or more specific hardware demands that the respective program module requires for its proper execution on the computing platform 700. Accordingly, the second attribute set 1020 of a respective module-based computer program may be derived, e.g., by a simple aggregation or in any other suitable manner (such as selecting maximum requirement demands) from the respective individual module-level requirement attribute sets 1350 of the program modules contained or otherwise used (e.g., by means of linking-in a module from an inventoried software module library) by the computer program.

In the present example of FIG. 17, there are seven different program modules in total, namely a first program module 1305, a second program module 1310, a third program module 1315, a fourth program module 1320, a fifth program module 1325, a sixth program module 1330, and a seventh program module 1335. Some of the program modules, namely the third program module 1315 and the sixth program module 1330, are used by more than one of the computer programs. Each of the program modules has a respective assigned module-level requirement attribute set 1350 and the respective second attribute set 1020 of each computer program is derived from the module-level requirement attribute sets 1350 of the program modules it uses.

The method may be performed by an evaluation system 1340 for evaluating a proper functioning of the computing system. The evaluation system 1340 comprises a data processing apparatus comprising a processor configured to perform the method. The data processing apparatus may be separate from the computing system or may instead coincide or form a part of the to-be-evaluated computing platform 700 itself. For example, when the computing platform 700 is provided by CCU 105, then the processor may be a processor of one of the CES of CCU 105. The method may be implemented by a resource management function 1360 which may particularly be implemented, in whole or part, in software. For example, the resource management function 1360 may be included in an operating system 1345 or as an application program designed to run on-top of the operating system 1345.

The resource management function 1360 receives or accesses both the second attribute sets 1020 of the computer programs and a first attribute set 1015 of a selected hardware entity or a joint first attribute set 1015 of a group of selected hardware entities, on which the computer programs are supposed to run.

The resource management function 1360 then performs a comparison wherein (i) the combined hardware demand of the computer programs as represented by an aggregation or other suitable combination of the second attribute sets 1020 to the technical properties of the computing unit as represented by the first attribute set 1015 to determine and output an evaluation result 1365 indicating whether the respective hardware demand can be met by the computing system. The comparison may particularly take a predefined headroom requirement for the computing platform 700 into account, so that situations can be avoided, where the hardware requirements can only be met by a very little margin thus leaving little room for flexibility or varying computing power.

If the evaluation result 1365 indicates that the combined hardware demand of all three computer programs can be met, the third computer program 920 may be executed simultaneously with the first computer program 905 and the second computer program 910.

Otherwise, a warning is output and execution of the third computer program 920 is blocked, e.g., by means of the operating system 1345, at least until enough hardware resources for its proper operation become available again, e.g., if one or both of the first computer program 905 and the second computer program 910 are terminated or need less relevant hardware resources, e.g., computing power, than before. Also, other countermeasures are possible, such as disabling one or more functionalities of the computing platform 700, interrupting or otherwise disabling an execution of one or more of the computer programs, and so forth (see further above).

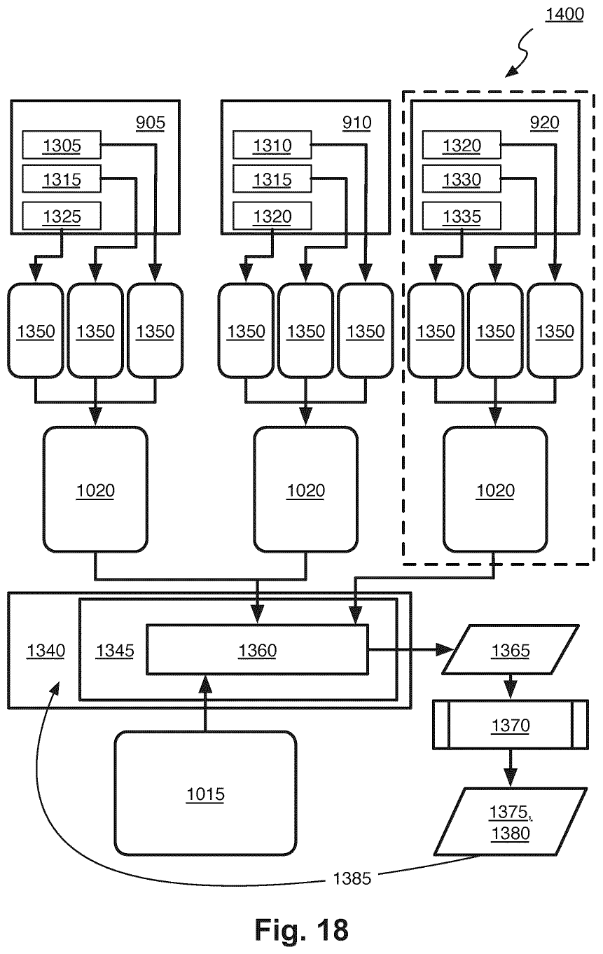

FIG. 18 illustrates a second embodiment 1400 of the present method, which is based on and largely similar to the first embodiment 1300. In contrast thereto, it addresses an alternative situation, where an evaluation is to be performed whether an updating or upgrading of one or more computer programs that are already present (in a prior version) in the computing system can still be properly operated without running into a lack of sufficient hardware resources. In the present example, the third computer program 920 shall be updated. The update may particularly include modifications of the third computer program 920 which require for certain routines in the third computer programs 920 a higher computing power than the currently installed prior version of the third computer program 920.

While in principle, the first embodiment 1300 might be used to perform such an evaluation in that the upgrade is performed and then the evaluation per FIG. 17 is performed, this does not allow for a pre-upgrade evaluation and if the evaluation yields an evaluation result 1365 indicating a lack of sufficient hardware resources, the upgrade will typically have to be reversed.

Therefore, in the second embodiment 1400 the evaluation is performed before an actual update or upgrade is performed, solely on the basis of a comparison of the combined first attribute set 1015 of the computing platform 700 or of selected relevant hardware entities thereof and the second attribute sets 1020 of the computer programs including the second attribute set 1020 of the update/upgrade version of the third computer program 920.

If the evaluation result 1365 indicates that the combined hardware demand of the first computer program 905, the second computer program 910 and the update/upgrade-version of the third computer program 920 can be met, the third computer program 920 may be updated/upgraded accordingly. Otherwise, the update/upgrade is either rejected, or (as illustrated in FIG. 18) an optimization process 1370 is triggered by which the hardware demands of the update/upgrade version are reduced by modifying one or more operational parameters of the update/upgrade version. For example, if the third computer program 920 is a camera application, such an optimization process 1370 may particularly include a reduction of one or operational parameters defining a sampling rate of the camera application, which in turn may result in a reduced hardware requirement in terms of computing power and/or memory space needed to properly support the camera application.

Instead, or cumulatively, the optimization process 1370 may include a real or virtual modification of the hardware resources, e.g., by adding another hardware entity, e.g., a more powerful CE or whole computing module, to cover the extended hardware demand of the update/upgrade version of the third computer program 920. Accordingly, the optimization process 1370 results in a modified second attribute set 1380 of the third computer program 920 and/or a modified first attribute set 1375 of the computing platform 700.

Based thereon, a reassessment 1385 can be performed to yield an updated evaluation result 1365′ in relation to the optimized situation. Multiple iterations are possible. The finally achieved updated evaluation result 1365′ may then be treated similarly as the evaluation result 1365 according to the first embodiment 1300.

Generally, in both embodiments, the set of considered attributes in the first attribute set 1015 and/or the second attribute sets 1020 may be restricted to those attributes which are actually relevant for achieving a meaningful evaluation result 1365, while other attributes might be ignored for the purposes of evaluations for which they are not or only marginally relevant.

### LIST OF REFERENCE NUMERALS

100 First block diagram
105 CCU
110 Computer module cluster
115 Main computing module
115a First computational entity (CE)
115a-1 First instantiation of the first master CE
115a-2 Second instantiation of the first master CE
115b Second computational entity
115b-1 First instantiation of the second master CE
115b-2 Second instantiation of the second master CE
115c Further CEs
115d Resource coordination functionality
115e Safety management system
115f Central fault management system
115g Own individual FMS
120 General purpose computing module
120a Autonomous CE
120b Additional CE
120c Individual fault management system
125 Special purpose module
125a Special CE
125b Communication interface
125c Special individual fault management system
130 Connection device
135 Service module
140 First endpoint cluster
145 Second endpoint cluster
150 Third endpoint cluster
155 Fourth endpoint cluster
160 Intermediate wireless transceiver
170 A first pair
170a, b Pair
170b Second pair
200 Second block diagram
201 Redundancy concept
205 Computing task coordination domain
210 Control coordination domain
215 Fabric power coordination domain
220 Power supply domain
225a First switching fabric
225a-1 First instantiation of the first switching fabric
225a-2 Second instantiation of the first switching fabric
225b Second switching fabric
225b-1 First instantiation of the second switching fabric
225b-2 2nd instantiation of the second switching fabric
225c Third switching fabric
230a, b First security functions
235a, b Second security functions
240a First main power source
240b Second main power source
240c Emergency power source
245a, b Current limiters
250a, b First voltage generation units
255a, b Second voltage generation unit
260a, b Controller
265a, b Monitoring unit
270a First configuration switch
270a, b Configuration switch
300 Hierarchical communication scheme
305 First central processing unit (CPU)
305a First management functionality
305b First processing functionality
305c First PCIe root complex
310 second CPU
310a Second management functionality
310b Second processing functionality
310c Second PCIe root complex
315 First PCIe root ports
320 Second PCIe root ports
325 PCIe switch
330 Endpoint
335 Inter-CPU communication link
400 Adapted PCIe communication scheme
405a Management functionality
405b processing functionality
405c First PCIe single root complex
405d PCIe root ports
410a Further management functionality
410b Further processing functionality
410c Second PCIe single root complex
410d Further PCIe root ports
415a Corresponding first PCIe switch
415a,b Hierarchy-related PCIe switch
415b Corresponding second PCIe switch
415d Resource coordination system block
420a, b First Non-transparent PCIe Bridges (NTB)
425a, b Second Non-transparent PCIe Bridges (NTB)
430 PCIe endpoint
430-1 First selected PCIe endpoint
430-2 Second selected PCIe endpoint
435 First communication path
440 Second communication path
445 Third communication path
500 Third block diagram
505 Conversion bridge
510 Ethernet switch
515 Endpoint cluster
600 Housing
605 Housing structure
610 Connectors
700 Computing platform
710 Cluster hub
715 Actuator
720 Sensor
725 High-speed communication link
730 Signal connection
735 First interface unit
740 First computing layer
745 Second interface unit
750 Third computing layer
800 Vehicle
805 First location
810 Second location
815 Third location
900 Scenario
905 First computer program
910 Second computer program
915 Computing core
920 Third computer program
925 Fourth computer program
930 Fifth computer program
1000 Attribute assignment scheme
1005 Property attribute
1010 Requirement attribute
1015 First attribute set
1020 Second attribute set
1100 Concept of an abstract hardware entity
1105 Abstract hardware entity
1110 Real instantiation
1200 Table
1300 First embodiment
1305 First program module
1310 Second program module
1315 Third program module
1320 Fourth program module
1325 Fifth program module
1330 Sixth program module
1335 Seventh program module
1340 Evaluation system
1345 Operating system
1350 Module-level requirement attribute set
1360 Resource management function
1365 Evaluation result
1365′ Updated evaluation result
1370 Optimization process
1375 Modified first attribute set
1380 Modified second attribute set
1400 Second embodiment
A Alarm information
C Control information
D Data
I Power management information
ID Unique identifier
O Fiber communication link
P (Electrical) power
W Wireless communication link

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-26. (canceled)

27. A method of automatically evaluating a proper functioning of a computing system configured as a centralized on-board computing system for a vehicle to centrally control a variety of different functionalities of the vehicle, the computing system comprising:
a computing platform having a plurality of hardware entities, and
a plurality of different computer programs being configured for individual or concurrent execution on the computing platform to enable one or more of said functionalities of the vehicle; and
the method comprising:
assigning to or accessing for one or more of the hardware entities an associated set of one or more individual property attributes representing individually or jointly one or more technical properties of the respective hardware entity;
assigning to or accessing, individually for one or more of the computer programs or jointly for a subset comprising two or more of the computer programs, an associated set of one or more requirement attributes representing individually or jointly one or more specific hardware demands that the computer program or subset of computer programs, respectively, requires for its proper execution on the computing platform; and
comparing the respective individual hardware demands of one or more of the computer programs or a combined hardware demand of the subset of computer programs, respectively, to the technical properties of the computing platform as defined by the property attributes to determine an evaluation result indicating whether the respective hardware demand can be met by the computing system.

28. The method of claim 27, wherein the computing system comprises a central computing unit, CCU, configured as a centralized on-board computing system for the vehicle to centrally control a variety of different functionalities of the vehicle, and the method is applied to automatically evaluate a proper functioning of the CCU, wherein the CCU comprises:
a distributed computing system, DCS, comprising a plurality of co-located, autonomous computational entities, CEs, each of which has its own individual memory, wherein the CEs are configured to communicate among each other by message passing via one or more communication networks to coordinate among them an assignment of computing tasks to be performed by the DCS as a whole;
a communication switch comprising a plurality of mutually independent switching fabrics, each configured to variably connect a subset or each of the CEs of the DCS to one or more of a plurality of interfaces for exchanging thereover information with computing system-external communication nodes of the vehicle; and
a power supply system comprising a plurality of power supply sub-systems for simultaneous operation, each of which is individually and independently of each other capable of powering the DCS and at least two of the switching fabrics.

29. The method of claim 27, wherein at least one of the computer programs comprises two or more program parts designed for reuse by multiple ones of the computer programs, each program part having or being assigned one or more individual module-level requirement attributes representing individually or jointly one or more specific hardware demands that the respective program part requires for its proper execution on the computing platform; and
assigning the related set of one or more individual requirement attributes to each of these computer programs comprises deriving their respective set of individual requirement attributes, at least in parts, by combining the respective individual module-level requirement attributes being assigned to their respective program parts.

30. The method of claim 29, wherein the computing system comprises two or more of said computer programs and at least a subset of the reusable program parts are included as elements in an inventoried software part library in such a way that they can be individually integrated or accessed by different ones of the computer programs via the inventory, so that evaluating the proper functioning of the computing system comprises performing the evaluation based on said two or more computer programs including said subset of reusable program parts being integrated in or accessed by one or more of the computer programs, respectively.

31. The method of claim 27, wherein defining the technical properties of the computing system through the set of the property attributes of the one or more hardware entities comprises defining one or more abstract hardware entities each of which virtually represents by means of a set of respective individual property attributes per each abstract hardware entity a group of different possible real instantiations of such a hardware entity.

32. The method of claim 27, wherein at least one of the property attributes is individually encoded by a respective unique and computer-readable property identifier; and
when comparing the individual hardware demands of the one or more computer programs or the combined hardware demand of the subset of computer programs, respectively, to the technical properties of the computing unit, at least one of the property identifiers is decoded to determine the property attribute encoded by said property identifier as a basis for the comparison.

33. The method of claim 27, wherein at least one of the requirement attributes is individually encoded by a respective unique and computer-readable requirement identifier; and
when comparing the individual hardware demands of the one or more computer programs or the combined hardware demand of the subset of computer programs, respectively, to the technical properties of the computing unit, at least one of the requirement identifiers is decoded to determine the requirement attribute encoded by said requirement identifier as a basis for the comparison.

34. The method of claim 32, wherein a string representation comprising two or more concatenated identifiers is used to represent a particular combination of selected identifiers as a basis for the comparison.

35. The method of claim 32, wherein encryption technology is used to protect at least a subset of the one or more identifiers against unauthorized access.

36. The method of claim 32, wherein obfuscation technology is used to protect at least a subset of the one or more identifiers against unauthorized access by applying time-variant associations between at least one particular identifier on the one hand and the respective information being temporarily encoded therewith on the other hand.

37. The method of claim 32, wherein at least a subset of the attributes is organized in a hierarchical order that is reflected in corresponding hierarchical codes used to encode the related set of identifiers.

38. The method of claim 27, wherein the method further comprises:
preselecting, based on the set of the requirement attributes, a relevant subset of the property attributes of the processing platform; and
performing the comparison, in terms of the property attributes being considered, strictly on the basis of the preselected property attributes.

39. The method of claim 27, wherein the set of one or more computer programs or at least one of the computer programs therein is reconfigurable by adding, removing, enabling, or disabling or modifying one or more computer programs or computer program parts, respectively; and
the method further comprises:
determining an actual or planned reconfiguration of the set of one or more computer programs or of at least one of the computer programs itself; and
performing the method to determine information indicating whether or not, according to the result of the related comparison, the respective individual or combined hardware demands of the set of one or more computer programs or the at least one computer program itself, when or if reconfigured accordingly including a respective updating of the related one or more requirement attributes, can be met by the technical properties of the computing system.

40. The method of claim 27, wherein the computing unit is reconfigurable by adding, removing, enabling, or disabling or modifying, respectively, one or more of its hardware entities; and
the method further comprises:
determining an actual or planned reconfiguration of the computing unit; and
performing the method to determine information indicating whether or not, according to the result of the related comparing, the respective individual or combined hardware demands of the one or more computer programs can be met by the technical properties of the computing unit, when or if reconfigured accordingly including a respective updating of the related one or more property attributes.

41. The method of claim 27, wherein the method further comprises one or more of the following actions in response to determining that according to the result of the related comparing, the respective individual or combined hardware demands of the one or more computer programs cannot be met by the technical properties of the computing unit:
initiating a warning signal;
disabling one or more functionalities of the computing unit or its operation as a whole;
interrupting or otherwise disabling execution of at least one of the computer programs on computing unit;
outputting further information indicating a property attribute or other related hardware requirement that according to the result of the related comparison cannot be met;
outputting further information indicating a degree to which a property attribute or other related hardware requirement cannot be met according to the result of the related comparison;
preventing an updating of one or more of the computer programs or of one or more computer program parts incorporated therein;
communicating a result of the comparing to a remotely accessible computing environment or data storage;
requesting or proposing an exchange of one or more hardware entities of the computing system or an addition of one or more other or further hardware entities to the computing system, such as to enable the computing system to meet said respective individual or combined hardware demand;
estimating, for a defined time interval, a probability that an exchange or addition of one or more hardware entities of the computing system becomes necessary with the time interval in order to meet expected individual or combined hardware demands based on a trend analysis of previously occurring computer program updating and/or upgrading cycles.

42. The method of claim 27, wherein the comparing comprises taking into account a predefined headroom requirement for the computing system as a further hardware demand for determining whether the respective hardware demand of a computer program or the combined hardware demand of two or more of the computer programs, respectively, can be met by the technical properties of the computing system.

43. The method of claim 27, wherein the method is performed using at least one of the following: an the computing system operating system running on itself; a processing apparatus other than the computing unit of the computing system.

44. The method of claim 27, wherein at least one computer program being involved in the comparing of the respective individual hardware demands of one or more of the computer programs or a combined hardware demand of the subset of computer programs, respectively, to the technical properties of the computing unit is a respective updated or upgraded version of a computer program a prior version of which already belongs to the computing system, in addition to or instead of the prior version.

45. The method of claim 44, wherein when the evaluation result indicates that the individual hardware demand of the updated or upgraded version or a combined hardware demand of the subset of computer programs including the updated or upgraded version, respectively, cannot be met by the computing system,
one or more operational parameters of the updated or upgraded version are modified such as to reduce its hardware demand, and
the evaluation is repeated based on such reduced hardware demand.

46. The method of claim 27, wherein said functionalities of the vehicle to be centrally controlled by the computing system comprise one or more of the following, at least in parts:
engine control;
entertainment or infotainment;
lighting;
locking;
air conditioning;
braking;
driver assistance;
navigation;
automated or autonomous driving;
vehicle-internal or vehicle-external communication;
configuration of the vehicle's interior; and
the evaluation is performed to evaluate a proper functioning of the computing system in relation to its capability to properly perform at least one or a combination of two or more of said functionalities.

47. The method of claim 27, wherein the method further comprises an initialization process comprising one or more of:
automatically detecting one or more of the hardware entities and determining or receiving for each of these hardware entities its respective associated set of one or more individual property attributes;
receiving information specifying one or more of the hardware entities and determining or receiving for each of these hardware entities its respective associated set of one or more individual property attributes;
automatically detecting one or more of the computer programs and determining or receiving for each of these computer programs individually or for a set comprising two or more of these computer programs an associated set of one or more requirement attributes representing individually or jointly one or more specific hardware demands that this computer program or set of computer programs, respectively, requires for its proper execution on the computing platform;
receiving information specifying one or more of the computer programs and determining or receiving for each of these computer programs individually or for a set comprising two or more of these computer programs an associated set of one or more requirement attributes representing individually or jointly one or more specific hardware demands that this computer program or set of computer programs, respectively, requires for its proper execution on the computing platform.

48. An evaluation system for evaluating a proper functioning of a computing system being configured as an on-board computing system for a vehicle to centrally control different functionalities of the vehicle and comprising a computing platform having a plurality of hardware entities, and a plurality of different computer programs being configured for individual or concurrent execution on the computing platform;
wherein the evaluation system comprises a processor configured to perform the method of claim 27 to evaluate a proper functioning of the computing system.

49. A computing system configured as a centralized on-board computing system for a vehicle, such as an automobile, to centrally control different functionalities of the vehicle, wherein the computing system comprises the evaluation system of claim 48 for evaluating a proper functioning of the computing system itself.

50. The computing system of claim 49, wherein the computing system comprises a central computing unit, CCU, configured as an on-board computing unit for the vehicle to centrally control different functionalities of the vehicle, the CCU comprising:
a distributed computing system, DCS, comprising a plurality of co-located, autonomous computational entities, CEs, each of which has its own individual memory, wherein the CEs are configured to communicate among each other by message passing via one or more communication networks to coordinate among them an assignment of computing tasks to be performed by the DCS as a whole;
a communication switch comprising a plurality of mutually independent switching fabrics, each configured to variably connect a subset or each of the CEs of the DCS to one or more of a plurality of interfaces for exchanging thereover information with computing system-external communication nodes of the vehicle; and
a power supply system comprising a plurality of power supply sub-systems for simultaneous operation, each of which is individually and independently of each other capable of powering the DCS and at least two of the switching fabrics.

51. A vehicle comprising the computing system of claim 49 as a centralized on-board computing system.

52. A non-transitory computer-readable storage medium comprising instructions which when executed on a computer or a multi-computer platform cause the computer or multi-computer platform, respectively, to perform the method of claim 27 to evaluate the computing system.
